(19) United States
(12) Patent Application Publication
(10) Pub. No.: US 2013/0096992 A1
(43) Pub. Date: Apr. 18, 2013

(54) SHAREHOLDER MANAGEMENT APPARATUS, SHAREHOLDER MANAGEMENT METHOD, AND PROGRAM

(71) Applicant: Investor Networks Inc., Tokyo (JP)

(72) Inventors: Mitsuo Sugimoto, Tokyo (JP); Naoki Matsuda, Tokyo (JP)

(73) Assignee: INVESTOR NETWORKS INC., Tokyo (JP)

(21) Appl. No.: 13/647,734

(22) Filed: Oct. 9, 2012

(30) Foreign Application Priority Data
Oct. 13, 2011 (JP) 2011-225472

(51) Int. Cl. G06F 17/30; G07C 13/00

(52) U.S. Cl. 705/12; 707/769; 707/E17.014

(57) ABSTRACT

To promote computerization of exchange of various data, etc., between a listed corporation and its individual shareholders. An individual shareholder management apparatus includes an individual shareholder client terminal, an individual shareholder management server connected to the individual shareholder client terminal through a network, and a database group including an individual shareholder database connected to the individual shareholder management server.

### BACKGROUND OF THE INVENTION

1. Field of the Invention

The present invention relates to a shareholder management technology using computer software, and in particular, to a management technology of shareholder relations (SR) (individual shareholders).

2. Background Art

Generally, in order to participate in voting of shareholders' meeting of a corporation that has issued shares, a shareholder attends the shareholders' meeting and participates by direct voting. However, when the shareholder cannot attend the shareholders' meeting for certain reasons, the shareholder can participate in the voting by sending a vote on the voting content (voting right exercise form) in writing to the corporation that has issued shares by mail before the shareholders' meeting (see JP Patent Publication (Kokai) No. 2003-203135A).

The management of shareholders of a listed corporation, etc., is generally performed by a securities company, a trust bank, etc. The trust bank receives information such as an address of a shareholder from the listed corporation, and sends a power of attorney for voting rights of the shareholders' meeting to the shareholder by mail in response to the information, and provides a returned reply to the listed corporation after receiving the reply from the shareholder. In addition, the shareholders can exercise their voting rights through a voting right exercise web system, however the listed corporation needs to pay an additional cost, and it is very time-consuming for the shareholder because the shareholders exercise their voting rights by accessing a webpage address described in a power of attorney sent by mail and inputting shareholder information whenever they access the webpage.

In addition, the management of individual shareholders is performed by the trust bank, and the listed corporation needs to pay an additional cost to receive shareholder information from the trust bank by electronic data because, generally, the listed corporation receives the shareholder information from the trust bank by a paper medium. In addition, in data for the management, computerization has not been performed on contact information such as a telephone number and an e-mail address.

### SUMMARY OF THE INVENTION

However, it takes costs for the voting right exercise system by mail and the current electronic voting right exercise system, and in particular, in many cases, an individual shareholder does not exercise the voting rights, and such a situation is not desirable. When the computerization is performed on data for the management, an approach to the individual shareholder for the voting right exercise, etc. is facilitated.

An object of the present invention is to promote computerization of exchange of various data, etc., between a listed corporation and its individual shareholders. In addition, the object of the present invention is also to, by the computerization, provide various ways in which a feeling of solidarity is inspired between the individual shareholders and the listed corporation by making the individual shareholders more familiar with the listed corporation, and the individual shareholders are encouraged to become a stable shareholder by promoting long-term shareholding.

### (Digitalization of Processes: Sending of a Disk)

According to an aspect of the present invention, an individual shareholder management apparatus includes: an individual shareholder client terminal; an individual shareholder management server connected to the individual shareholder client terminal through a network; and a database group including an individual shareholder database connected to the individual shareholder management server. The individual shareholder database includes, for each individual shareholder, at least: an individual shareholder table that includes an attribute of an individual shareholder for each unique individual shareholder identification (ID); an individual shareholder corporate attribute table that includes the individual shareholder ID that associates an individual shareholder and a corporation that has issued shares for each individual shareholder corporate attribute ID, a securities code that is a stock securities ID, and a latest shareholder number; and a storage medium log table that includes the individual shareholder corporate attribute ID, a storage medium unique ID, and a serial number enclosed with the storage medium and manages the contents in the storage medium and the provision state for each storage medium log ID for identifying a storage medium sent to the individual shareholder (by mail). In addition, the individual shareholder management apparatus further includes an information processing unit to perform a search and check process of data of the database group, and the information processing unit checks the storage medium unique ID obtained by reading the storage medium by the individual shareholder client terminal against a storage medium unique ID in the storage medium log table, obtains an individual shareholder corporate attribute ID corresponding to the checked storage medium log ID in the storage medium log table, obtains a latest shareholder number by search of the individual shareholder corporate attribute table using the individual shareholder corporate attribute ID as a key, provides the latest shareholder number for a client terminal held by the individual shareholder, checks the serial number replied from the individual shareholder against a serial number in the storage medium log table in response to the reply of the serial number from the individual shareholder, and obtains data that is stored in the individual shareholder corporate attribute table and associated by the individual shareholder corporate attribute ID on condition of the verification of the serial numbers.

By the above-described process, the verification with a serial number in the storage medium log table is performed using the storage medium sent to the individual shareholder (by mail) as a key, and the correspondence between corporate attributes of the individual shareholder, in particular between an individual shareholder ID and a securities code can be obtained by obtaining data that is stored in the shareholder corporate attribute table and associated with the individual shareholder corporate attribute ID on the condition of the verification of the serial numbers.

### (Digitalization of Processes: Addition of a Contact Item of Individual Shareholder Information By Obtaining an E-Mail Address)

The information processing unit obtains and creates data that is used to display a personal information input screen on the client terminal and used to display a screen for an input including an input column for inputting an e-mail address by search of the individual shareholder table based on data of the individual shareholder table associated with the individual shareholder corporate attribute table and the individual shareholder corporate attribute ID associated by the obtained individual shareholder corporate attribute ID, prompts the client terminal to submit the e-mail address, and stores the e-mail address input from the client terminal in the screen display for the input in the individual shareholder table.

By the above-described process, an e-mail address of an individual shareholder is obtained to be stored as individual shareholder information.

As a result, an e-mail address of an individual shareholder that is a key for performing exchange of various data is obtained to create an individual shareholder table. Thus, the digitalization of the management and the process can be performed based on the individual shareholder table. The following processes can be digital processed by e-mail, etc.

### (Login Screen Creation Process)

When the information processing unit stores the e-mail address, the information processing unit registers a temporary key for user registration confirmation to a timed key table that stores an individual shareholder ID of the individual shareholder table with a timed key, prompts the reference of a URL in which the temporary key is embedded by sending an e-mail including the URL to the e-mail address of the client terminal, extracts the temporary key from the URL in response to the reference of the URL, extracts an individual shareholder ID by search of the timed key table based on the timed key, and extracts user information by search of the individual shareholder table based on the individual shareholder ID to obtain data for creating a login screen.

### (Voting Right Setting and Answer Process)

In addition, according to another aspect of the present invention, an individual shareholder management apparatus includes: an individual shareholder client terminal; an individual shareholder management server that is connected to the individual shareholder client terminal through a network; and a database group that includes an individual shareholder database and a distribution action database that are connected to the individual shareholder management server, an individual shareholder search condition database, and a voting right exercise database. The individual shareholder database includes, for each individual shareholder, at least: an individual shareholder table that includes an attribute of an individual shareholder for each unique individual shareholder ID; and an individual shareholder corporate attribute table that includes the individual shareholder ID that associates the individual shareholder and a corporation that has issued shares, a securities code that is a stock securities ID, and a latest shareholder number for each individual shareholder corporate attribute ID. In addition, the individual shareholder management apparatus further includes an information processing unit that performs a search and check process of data of the database group. In the distribution action database, the information processing unit obtains a search condition saving ID item that is identified by a distribution action ID of a distribution action setting table for setting a distribution action item for each distribution action ID, from a search condition distribution destination table including a distribution action ID and a search condition saving ID and stores the search condition saving ID item, searches a search condition saving table that includes a search condition item for each of the search condition saving IDs using the search condition saving ID as a key, obtains, based on the search condition saving ID, each search condition from a search condition saving mapping table that includes a search condition saving ID and an individual shareholder attribute ID, an individual shareholder range search condition table that identifies a condition of a search range of an individual shareholder for each individual shareholder range search condition ID, an individual shareholder range search condition option table that includes an individual shareholder range search condition ID and an option name for each individual shareholder range search condition option ID, an individual shareholder range search condition saving mapping table that includes a search condition saving ID and an individual shareholder range search condition option ID, and an extended attribute search condition saving mapping table that includes the search condition saving ID and an individual shareholder extended attribute option ID, in order to build search conditions. In addition, the information processing unit searches, based on each of the obtained search conditions, the individual shareholder table, the individual shareholder corporate attribute table, and an individual shareholder corporate extended attribute answer table that includes the individual shareholder corporate attribute ID and the individual shareholder extended attribute option ID, obtains a distribution member by obtaining the individual shareholder ID of the individual shareholder table of corresponding data and the e-mail address of the individual shareholder client terminal, and in the distribution action database, the information processing unit registers data that is available for distribution to an individual shareholder distribution action log table that includes a distribution action ID, an individual shareholder ID for each log ID, and a distribution status based on the distribution action ID obtained by search under the condition that a distribution reservation time of a distribution action table is earlier than start date and time of the process and the individual shareholder ID obtained in the distribution member obtaining process. In the voting right exercise database, the information processing unit obtains data by search of the individual shareholder distribution action log table using an individual shareholder data (individual shareholder ID) in the login as a key in response to the login and reply to an e-mail that reports to the individual shareholder client terminal that voting right exercise is available and is sent based on the obtained e-mail address of the individual shareholder client terminal, obtains data of the distribution action setting table, a voting right exercise distribution setting table that includes the distribution action ID for each voting right exercise distribution setting ID, and a voting content table that includes a voting right exercise distribution setting ID and proposal content for each proposal ID, using the distribution action ID that is the data as a key, and prompts reply by sending data for displaying a voting right exercise screen on the individual shareholder client terminal.

### (Point Exchange)

In addition, according to another aspect of the present invention, an individual shareholder management apparatus includes: an individual shareholder client terminal; an individual shareholder management server that is connected to the individual shareholder client terminal through a network; and a database group that includes an individual shareholder database and a distribution action database that are connected to the individual shareholder management server, an individual shareholder search condition database, and a point exchange database. The individual shareholder database includes, for each individual shareholder, at least: an individual shareholder table that includes an attribute of an individual shareholder for each unique individual shareholder ID; and an individual shareholder corporate attribute table that includes the individual shareholder ID that associates the individual shareholder and a corporation that has issued shares, a securities code that is a stock securities ID, and a latest shareholder number for each individual shareholder corporate attribute ID. In addition, the individual shareholder management apparatus further includes an information processing unit that performs a search and check process of data of the database group. The information processing unit receives a product type (product category) that is replied in response to the menu selection from the individual shareholder client terminal, obtains data from an exchange point master table that includes a securities code for each exchange point ID, a product ID, and an exchange point, and a product master table that stores the product display contents including a product name for each product ID in the point exchange database using the securities code and the product type (product category) in response to the menu selection as keys, sends the data for displaying the point exchange product screen to the individual shareholder client terminal, obtains data from the product master table and the exchange point master table using a product ID for identifying the product as a search key in response to a product specified by replying in accordance with a product selection operation, sends data for displaying the detail of the selected product on the client terminal, obtains the number of held points (balance) of the individual shareholder corporate attribute table of the client terminal in response to the selection confirmation, determines whether or not the selected product and the points can be changed by comparing the selected product and the points, newly writes an exchange point and an application state identified by the individual shareholder ID in a point exchange log table that includes an individual shareholder ID and an exchange point for each log ID in the point exchange database, and updates the number of held points of the individual shareholder corporate attribute table by recalculating new held points obtained after the point exchange.

### (Search and Browsing of Shareholder Information)

In addition, according to another aspect of the present invention, an individual shareholder management apparatus includes: an individual shareholder client terminal; an individual shareholder management server that is connected to the individual shareholder client terminal through a network; and a database group that includes an individual shareholder database and a distribution action database that are connected to the individual shareholder management server, and an individual shareholder search condition database. The individual shareholder database includes, for each individual shareholder, at least: an individual shareholder table that includes an attribute of an individual shareholder for each unique individual shareholder ID; and an individual shareholder corporate attribute table that includes the individual shareholder ID that associates the individual shareholder and a corporation that has issued shares, a securities code that is a stock securities ID, and a latest shareholder number for each individual shareholder corporate attribute ID. In addition, the individual shareholder management apparatus further includes an information processing unit that performs a search and check process of data of the database group. When an obtaining request of shareholder information is issued through the login from the corporate client terminal, the information processing unit obtains individual shareholder attribute information by search of the individual shareholder corporate attribute table and the individual shareholder table through the individual shareholder corporate attribute table using the corporate securities code of the corporate client terminal as a search key, prompts an input of a search condition regarding the individual shareholder corporate attribute in the corporate client terminal in response to the replied shareholder corporate attribute information, searches the individual shareholder corporate attribute table, the individual shareholder table, and an individual shareholder corporate extended attribute answer table that includes the individual shareholder corporate attribute ID and the individual shareholder extended attribute option ID, in the individual shareholder database based on a securities code of the login corporation and the input search condition, in response to the input, replies after obtaining only a number of cases that has been searched for, and creates statistical data.

In addition, the information processing unit registers the search condition to the individual shareholder corporate attribute table and the individual shareholder table as a search condition of the individual shareholder based on the statistical data, obtains data by search of the registered individual shareholder corporate attribute table and the individual shareholder table in response to a shareholder information search request from the corporate client terminal, and replies to the corporate client terminal by sending an individual shareholder member list created based on the data.

According to another aspect of the present invention, an individual shareholder management method uses an individual shareholder management apparatus including an individual shareholder client terminal, an individual shareholder management server that is connected to the individual shareholder client terminal through a network, and a database group that includes an individual shareholder database connected to the individual shareholder management server. For each individual shareholder, the individual shareholder database includes at least: an individual shareholder table that includes an attribute of an individual shareholder for each unique individual shareholder ID; an individual shareholder corporate attribute table that includes an individual shareholder ID that associates the individual shareholder and a corporation that has issued shares for each individual shareholder corporate attribute ID, a securities code that is a stock securities ID, and a latest shareholder number; and a storage medium log table that includes the individual shareholder corporate attribute ID, a storage medium unique ID, and a serial number enclosed with the storage medium and manages the contents in the storage medium and the provision state for each storage medium log ID for identifying a storage medium sent to the individual shareholder (by mail). In addition, the individual shareholder management apparatus that used in the individual shareholder management method further includes an information processing unit to perform a search and check process of data of the database group, and the individual shareholder management method cause the information processing unit to execute: a step of checking the storage medium unique ID obtained when the storage medium is read against a storage medium unique ID in the storage medium log table and obtaining an individual shareholder corporate attribute ID of the storage medium log table; a step of obtaining a latest shareholder number by search of the individual shareholder corporate attribute table using the individual shareholder corporate attribute ID as a key; a step of providing the latest shareholder number for an client terminal held by the individual shareholder and checking the serial number replied from the individual shareholder against a serial number in the storage medium log table in response to the reply of the serial number from the individual shareholder; and a step of obtaining data that is stored in the individual shareholder corporate attribute table and associated by the individual shareholder corporate attribute ID on condition of the verification of the serial numbers.

In the present invention, a program may cause a computer to execute the above-described individual shareholder management method, and the program may be recorded to a computer-readable storage medium.

The contents described in the specification and/or figures of Japanese Patent Application No. 2011-225472, on which the claim of priority of present application is based, are incorporated in this specification by reference.

According to the present invention, the digitalization of the management of individual shareholders can be performed, thereby facilitating the management of voting right exercise, etc. In addition, through the computerization and point grant/product exchange, feeling of solidarity is inspired between the individual shareholders and the listed corporation by making the individual shareholders more familiar with the listed corporation, and the individual shareholders are encouraged to become a stable shareholder by promoting long-term shareholding.

### BRIEF DESCRIPTION OF THE DRAWINGS

FIG. 1 is a functional block diagram illustrating a general configuration example of a shareholder management system including a shareholder management apparatus according to an embodiment of the present invention.

FIG. 2A is a diagram illustrating one configuration example of an individual shareholder SR site server 1.

FIG. 2B is a diagram illustrating one configuration example of a corporate side shareholder information management server 3.

FIG. 2C is a diagram illustrating one configuration example of a batch server.

FIG. 3A is a diagram illustrating one configuration example of a client terminal.

FIG. 3B is a diagram illustrating one configuration example of a database (DB) server.

FIG. 4 is a diagram illustrating the outline of a data table in a DB.

FIG. 5 is a diagram illustrating the outline of the data table in the DB.

FIG. 6 is a diagram illustrating a configuration example of an individual shareholder table group.

FIG. 7 is a diagram illustrating a configuration example of the individual shareholder table group.

FIG. 8 is a diagram illustrating a configuration example of the distribution action table group.

FIG. 9 is a diagram illustrating a configuration example of an individual shareholder search condition table group.

FIG. 10A is a diagram illustrating a configuration example of a distribution action individual setting table group.

FIG. 10B is a diagram illustrating a configuration example of a distribution action individual setting table group.

FIG. 11 is a diagram illustrating a configuration example of a pre-voting right exercise questionnaire table group.

FIG. 12 is a diagram illustrating a configuration example of a voting right exercise table group.

FIG. 13 is a diagram illustrating a configuration example of a recognition survey questionnaire table group.

FIG. 14 is a diagram illustrating a configuration example of an action contract table group.

FIG. 15 is a diagram illustrating a configuration example of a point exchange table group.

FIG. 16 is a sequence diagram illustrating a member registration process.

FIG. 17 is a sequence diagram illustrating the member registration process.

FIG. 18 is a sequence diagram illustrating a voting right setting/answer process of proposal of shareholders' meeting, etc.

FIG. 19 is a sequence diagram illustrating the voting right setting/answer process of the proposal of the shareholders' meeting, etc.

FIG. 20 is a sequence diagram illustrating a process of point exchange.

FIG. 21 is a sequence diagram illustrating the process of point exchange.

FIG. 22 is a sequence diagram illustrating a flow of shareholder information search and browsing processes.

FIG. 23 is a diagram illustrating the outline of a process that causes member registration.

FIG. 24 is a diagram illustrating an example of a shareholder number input screen.

FIG. 25 is a diagram illustrating an example of a member shareholder recognition pattern.

FIG. 26 is a diagram illustrating an example of a personal information input screen.

FIG. 27 is a diagram illustrating an example of a questionnaire input screen.

FIG. 28 is a diagram illustrating an example of a registration confirmation screen.

FIG. 29 is a diagram illustrating an example of a registration completion screen.

FIG. 30 is a diagram illustrating the contents of an e-mail with URL for registration completion.

FIG. 31 is a diagram illustrating a login information registration screen.

FIG. 32 is a schematic view illustrating a screen transition example of user action from an SR server.

FIG. 33 is a diagram illustrating a login screen.

FIG. 34 is a diagram illustrating a top screen display of a shareholder community to which a user belongs.

FIG. 35 is a diagram illustrating an input screen of voting right exercise.

FIG. 36 is a diagram illustrating a confirmation screen of voting right exercise.

FIG. 37 is a diagram illustrating an answer completion screen of voting right exercise.

FIG. 38 is a diagram illustrating an example of a point exchange product type selection screen.

FIG. 39 is a diagram illustrating a point exchange product list.

FIG. 40 is a diagram illustrating the detail of a point exchange product.

FIG. 41 is a diagram illustrating an application confirmation screen of the point exchange product.

FIG. 42 is a diagram illustrating an application completion screen of the point exchange product.

FIG. 43 is screen transition diagram of an issuer corporation by IR-navi.

FIG. 44A is a diagram illustrating an image of an individual shareholder search screen.

FIG. 44B is a diagram illustrating an image of the individual shareholder search screen.

FIG. 45A is a diagram illustrating a display example of an individual shareholder member list screen.

FIG. 45B is a diagram illustrating a display example of the individual shareholder member list screen.

FIG. 46A is a diagram illustrating a display example of an action claim screen.

FIG. 46B is a diagram illustrating a display example of the action claim screen.

FIG. 47A is a diagram illustrating an example of a confirmation screen of a distribution result.

FIG. 47B is a diagram illustrating an example of the confirmation screen of the distribution result.

FIG. 47C is a diagram illustrating an example of the confirmation screen of the distribution result.

FIG. 47D is a diagram illustrating an example of the confirmation screen of the distribution result.

FIG. 47E is a diagram illustrating an example of the confirmation screen of the distribution result.

FIG. 48 is a diagram illustrating a screen transition example in an administrator side.

FIG. 49 is a diagram illustrating a display example of shareholder search and a search result list screen (M1-1).

FIG. 50 is a diagram illustrating a display example of a shareholder detailed screen.

FIG. 51 is a diagram illustrating a display example of a shareholder edit screen.

### DETAILED DESCRIPTION OF THE PREFERRED EMBODIMENTS

A shareholder management technology (an apparatus, a system, a program, a method, etc.) according to an embodiment of the present invention is described below with reference to accompanying drawings.

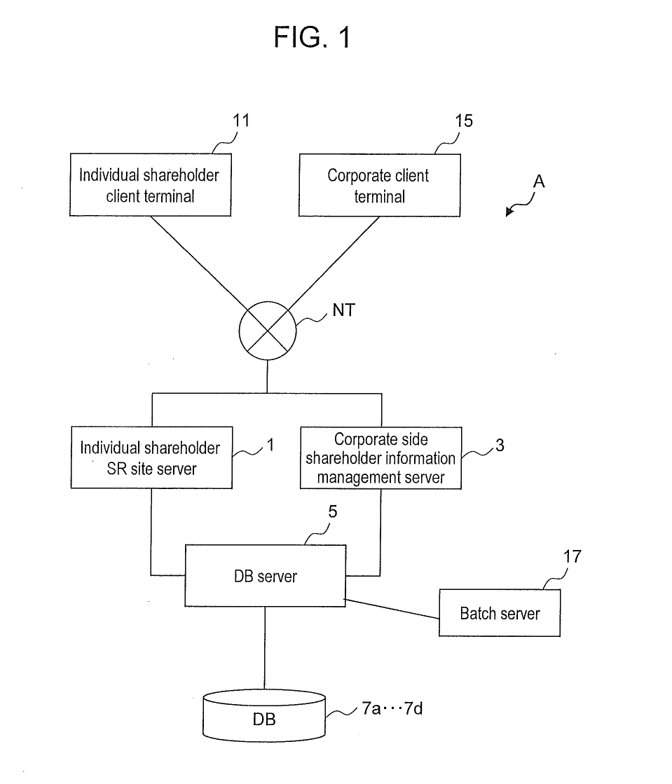

FIG. 1 is a functional block diagram illustrating a general configuration example of a shareholder management system including a shareholder management apparatus according to the embodiment of the present invention. A shareholder management system A illustrated in FIG. 1 includes an individual shareholder SR site (individual shareholder management) server 1, a corporate side shareholder information management server 3, a DB server 5 that is provided between the servers and DBs 7 (7a to 7d) and performs the management of the DB 7, and an individual shareholder client terminal 11 and a corporate client terminal 15 that are connected to the servers through a network (NT) such as the Internet.

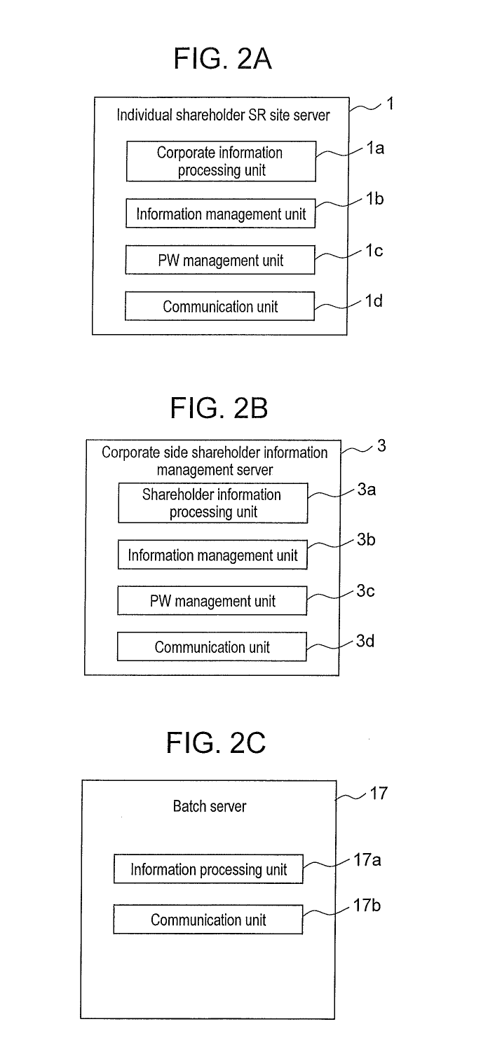

FIG. 2A is a diagram illustrating one configuration example of the individual shareholder SR site server 1. FIG. 2B is a diagram illustrating one configuration example of the corporate side shareholder information management server 3. The individual shareholder SR site server 1 illustrated in FIG. 2A includes a corporate information processing unit 1a that processes corporate information, an information management unit 1b that performs the management of information, a PW management unit 1c that manages security information of a password, etc., and a communication unit 1d that performs communication with the outside. The corporate side shareholder information management server 3 illustrated in FIG. 2B includes a shareholder information processing unit 3a that processes shareholder information, an information management unit 3b that performs the management of information, a PW management unit 3c that manages security information of a password, etc., and a communication unit 3d that performs communication with the outside. As illustrated in FIG. 2C, a batch server 17 includes an information processing unit 17a and a communication unit 17b.

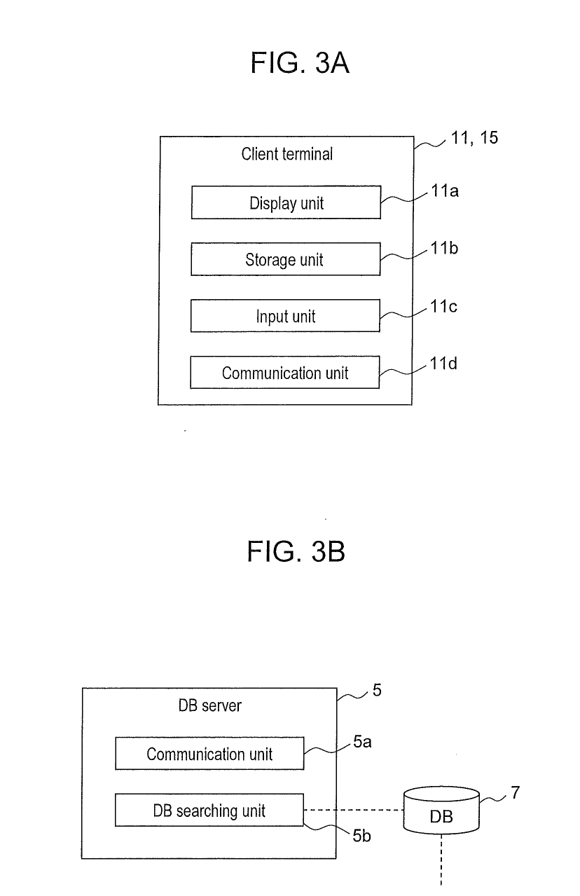

FIG. 3A is a diagram illustrating one configuration of the client terminals 11 and 15 using the individual shareholder client terminal 11 as an example. As illustrated in FIG. 3A, the individual shareholder client terminal 11 includes a display unit 11a such as a display, a memory that stores data, a storage unit 11b such as a hard disk drive (HDD), a keyboard that performs a data input, an input unit 11c such as a mouse, and a communication unit 11d that performs communication with the outside. Each of the client terminals 11 and 15 includes a personal computer (PC), a smartphone, and a mobile phone. As illustrated in FIG. 3B, the DB server 5 includes a communication unit 5a that is connected to the various DBs 7 and that performs communication with the outside and a DB searching unit 5b that performs search of a DB.

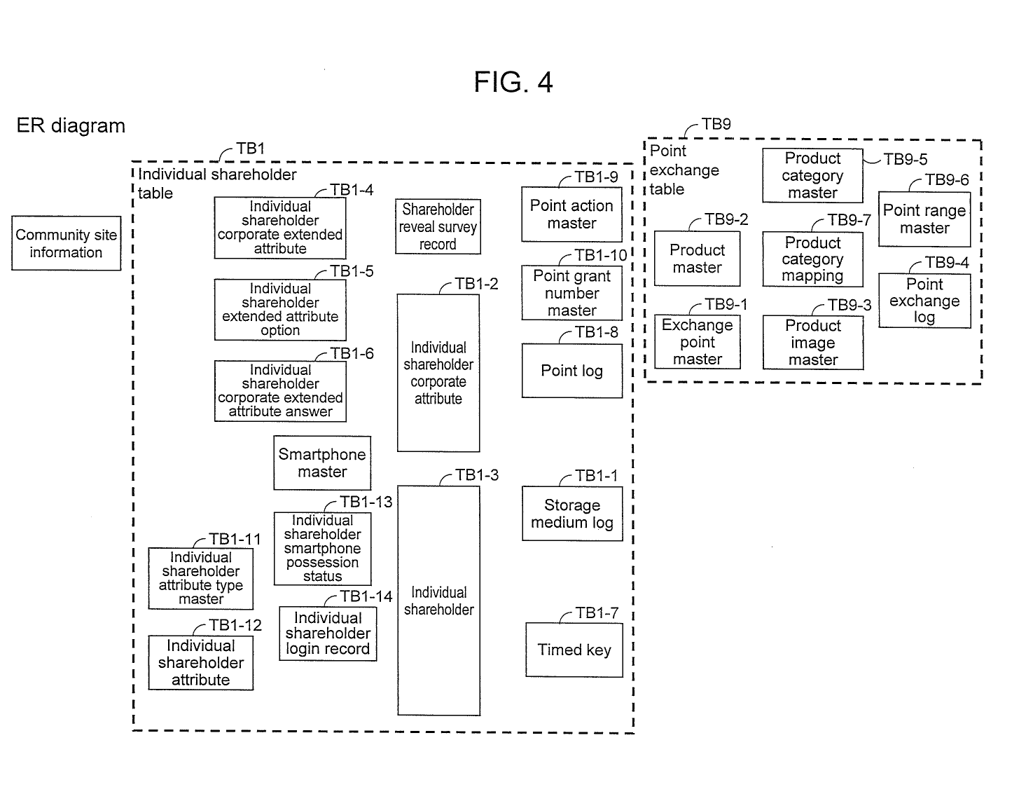

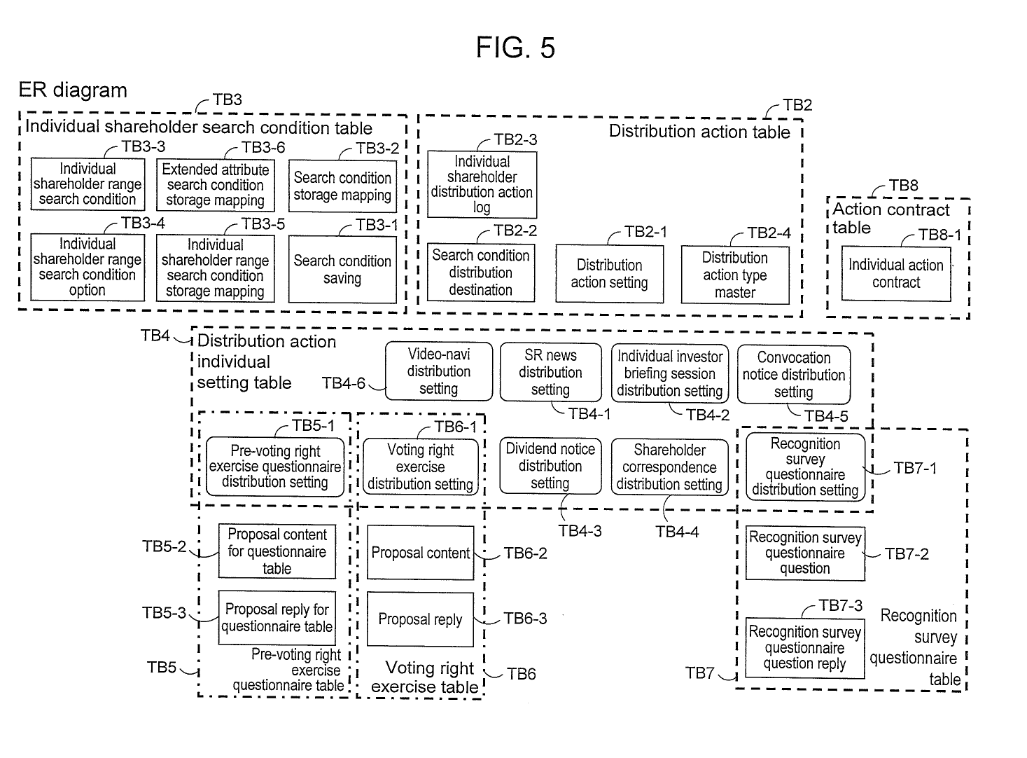

The content of the DB 7 is described below. FIGS. 4 and 5 are diagrams illustrating the outline of a data table in a DB. As illustrated in FIGS. 4 and 5, a data table according to the embodiment of the present invention includes an individual shareholder table group TB1 including information of an individual shareholder, a distribution action table group TB2 including information, etc. to the individual shareholder, an individual shareholder search condition table group TB3, a distribution action individual setting table group TB4, a pre-voting right exercise questionnaire table group TB5, a voting right exercise table group TB6, a recognition survey questionnaire table group TB7, an action contract table group TB8, and a point exchange table group TB9.

An individual investor user has one ID for the whole SR function in an “individual shareholder” table. A shareholding status for each corporation is managed using an “individual shareholder corporate attribute”. Even when the individual investor user holds shares in two or more corporations, the individual investor user can perform login using a unified ID/password on an individual basis. The management can be also performed by customizing a shareholder attribute for each corporation.

An “individual shareholder corporate extended attribute” is stored in related three tables TB1-4 to TB1-6. A corporation can perform the saving of a search condition of a corporation's individual shareholder (that includes a browsing member).

In six tables TB1-1 to TB1-6 related to an “individual shareholder search condition”, the corporation can perform an action for the shareholder using the stored search condition. However, a contract can be promoted by causing the performance of the action to be carried out only by a corporation that has an authority for accessing the corporate side shareholder information management server (IR server), for example, an IR-navi contract corporation.

The distribution of e-mail, etc., is managed in “distribution action” of the table TB2, and a start date and an end date of disclosure of the contents can be also specified. In addition, by the point exchange table group TB9, a product for point exchange, etc. can be managed. In this case, the whole products are managed in a “product master” table TB9-2, and an exchange product can be customized for each contract corporation in an “exchange point master” table TB9-1.

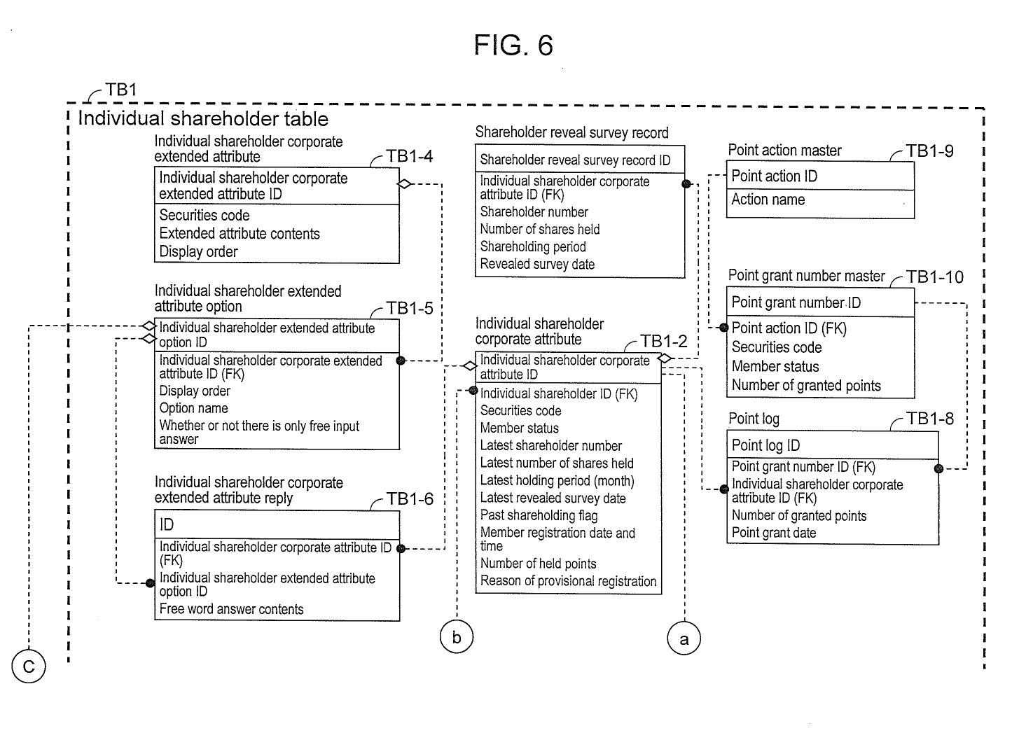

The table group is described in detail with reference to FIGS. 6 to 15.

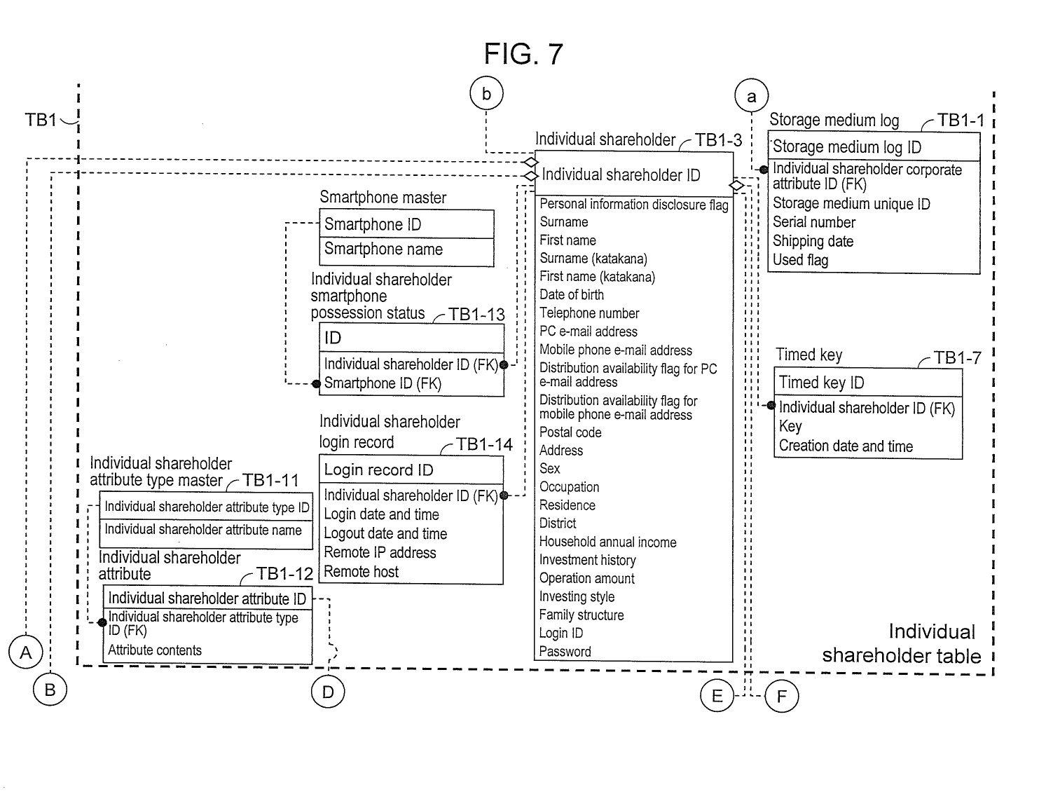

As illustrated in FIGS. 6 and 7, the individual shareholder table group TB1 includes a storage medium log table TB1-1 (the storage medium is available as various types such as a compact disc (CD), a memory card, and a universal serial bus (USB) memory. Hereinafter, the storage medium is referred to as a CD in the embodiments, and referred to as a storage medium in claims), an individual shareholder corporate attribute table TB1-2, an individual shareholder table TB1-3, the individual shareholder corporate extended attribute table TB1-4, the individual shareholder extended attribute option table TB1-5, the individual shareholder corporate extended attribute answer table TB1-6, a timed key table TB1-7, a point log table TB1-8, a point action master table TB1-9, a point grant number master table TB1-10, an individual shareholder attribute type master table TB1-11, an individual shareholder attribute table TB1-12, an individual shareholder smartphone possession status table TB1-13, and an individual shareholder login record table TB1-14. Not all the tables may be essential.

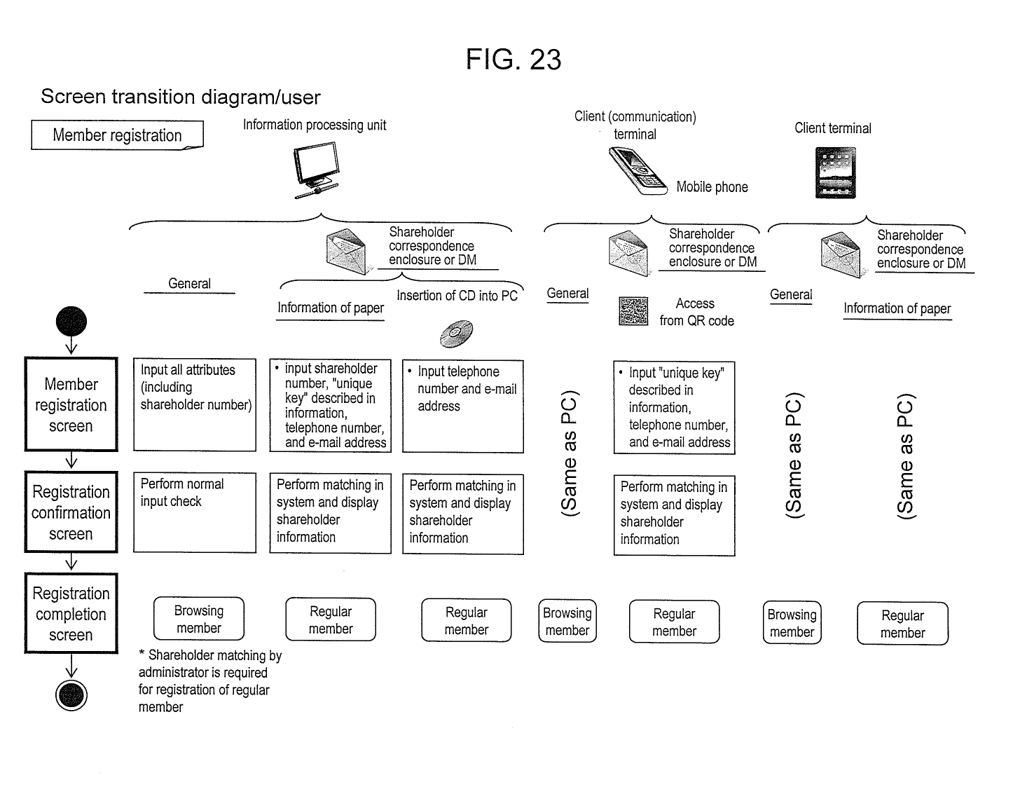

As described later in FIG. 23, the storage medium log table TB1-1 includes an individual shareholder corporate attribute ID, a storage medium unique ID, a serial number, a shipping date, and a used flag, for each storage medium log ID for identifying a CD that is sent to an individual shareholder, etc., and is provided as a storage medium such as a CD. By the table, the contents and the provision state of the CD can be managed.

The “storage medium unique ID” is a unique ID for identifying CDs one by one. In addition, “FK” is an abbreviation of “Foreign Key (external reference key)”, and a value of “PK” (Primary Key) of the related main table is entered to the “FK”. On the contrary, a value that is not entered to the “PK” of the main table can be entered to the “FK”. As a result, the tables can be associated with each other.

The individual shareholder corporate attribute table TB1-2 is a table for identifying an individual shareholder by a corporation, and for each individual shareholder corporate attribute ID of the individual shareholder managed by the corporation, includes an individual shareholder ID for identifying the individual shareholders themselves, a securities code, a member status for identifying a registration status, etc. of a member, a latest shareholder number, the latest number of shares held, a latest shareholding period (month), a latest revealed survey date, a past shareholding flag, member registration date and time, the number of held points, and a reason of provisional registration. There are two types of members, for example, of a browsing member and a regular member. The browsing member is a shareholder candidate member (a member who has bought shares and has not finished shareholder verification once every six months, or a member who has found not to hold shares by the shareholder verification once every six months) and is available for some functions of a shareholder site, and voting right exercise and dividend notice are not sent to the member. In addition, the product exchange by held points cannot be applied to the member, however regular member registration by system check or manual confirmation by an administrator can be performed. An input required attribute is the same as the attribute of a shareholder.

A regular member is a shareholder member, and a browsing member can become a regular member after being verified by the shareholder verification. The regular member can use all functions in the shareholder site and is a target for reversing the closing entry for prepaid expense at the beginning of next year, and in input attributes for the regular member, there are a basic portion (the number of shares, holding period, etc.) and a customized portion for each corporation.

The individual shareholder table TB1-3 stores, for each individual shareholder ID for uniquely identifying an individual shareholder, a personal information disclosure flag (flag of existence of disclosure of personal information), surname, first name, date of birth, a telephone number, a PC e-mail address, a mobile phone e-mail address, a distribution availability flag of each of the pieces contact information, an address, a postal code, sex, occupation, family structure, annual income, and investing style, etc., as attributes, in addition to a login ID and a password. By the table, basic information of the individual shareholder is covered, however, an annual income, etc. are optional items.

The individual shareholder corporate extended attribute table TB1-4 includes, for each individual shareholder corporate extended attribute ID, a securities code, an extended attribute contents, and a display order.

The individual shareholder extended attribute option table TB1-5 includes, for each individual shareholder extended attribute option ID, the above-described individual shareholder corporate extended attribute ID, a display order, an option name, and whether or not there is only free input answer, as an item. Here, when there is only free input answer, an option is only one and is not regarded as a search target.

The individual shareholder corporate extended attribute answer table TB1-6 includes, for each of the above-described individual shareholder corporate attribute IDs, an individual shareholder extended attribute option ID, and free word answer contents (additional answer and also served as a free input), as an item.

The timed key table TB1-7 includes, for each timed key ID, an individual shareholder ID, a key, and creation date and time.

The point log table TB1-8 includes, for each point log ID, a point grant number ID, an individual shareholder corporate attribute ID, the number of granted points, and a point grant date.

The point action master table TB1-9 includes, for each point action ID, an action name.

The point grant number master table TB1-10 includes, for each point grant number ID, a point action ID, a securities code, a member status, and the number of granted points.

The individual shareholder attribute type master table TB 1-11 includes, for each individual shareholder attribute type ID, an individual shareholder attribute name.

The individual shareholder attribute table TB1-12 includes, for each individual shareholder attribute ID, the above-described individual shareholder attribute type ID and attribute contents.

The individual shareholder smartphone possession status table TB1-13 is associated with a smartphone ID and includes an individual shareholder ID and a smartphone ID.

The individual shareholder login record table TB1-14 includes, for each login record ID, an individual shareholder ID, a login date and time, logout date and time, a remote IP address, and a remote host, as an item.

Here, the association between the tables is described. The storage medium log table TB1-1 is associated with the individual shareholder corporate attribute table TB1-2 by the individual shareholder corporate attribute ID. The individual shareholder corporate attribute table TB1-2 is associated with the point log table TB1-8 by the individual shareholder corporate attribute ID. The individual shareholder table TB1-3 is associated with the individual shareholder corporate attribute table TB1-2 by the individual shareholder ID, associated with the timed key table TB1-7 by the individual shareholder ID, and associated with the individual shareholder smartphone possession status table TB1-13 and the individual shareholder login record table TB1-14 by the individual shareholder ID.

The individual shareholder corporate extended attribute table TB1-4 is associated with the individual shareholder extended attribute option table TB1-5 by the individual shareholder corporate extended attribute ID. The individual shareholder extended attribute option table TB1-5 is associated with the individual shareholder corporate extended attribute answer table TB1-6 by the individual shareholder extended attribute option ID. The point action master table TB1-9 is associated with the point grant number master table TB-10 by the point action ID.

The individual shareholder attribute type master table TB1-11 is associated with the individual shareholder attribute table TB1-12 by the individual shareholder attribute type ID.

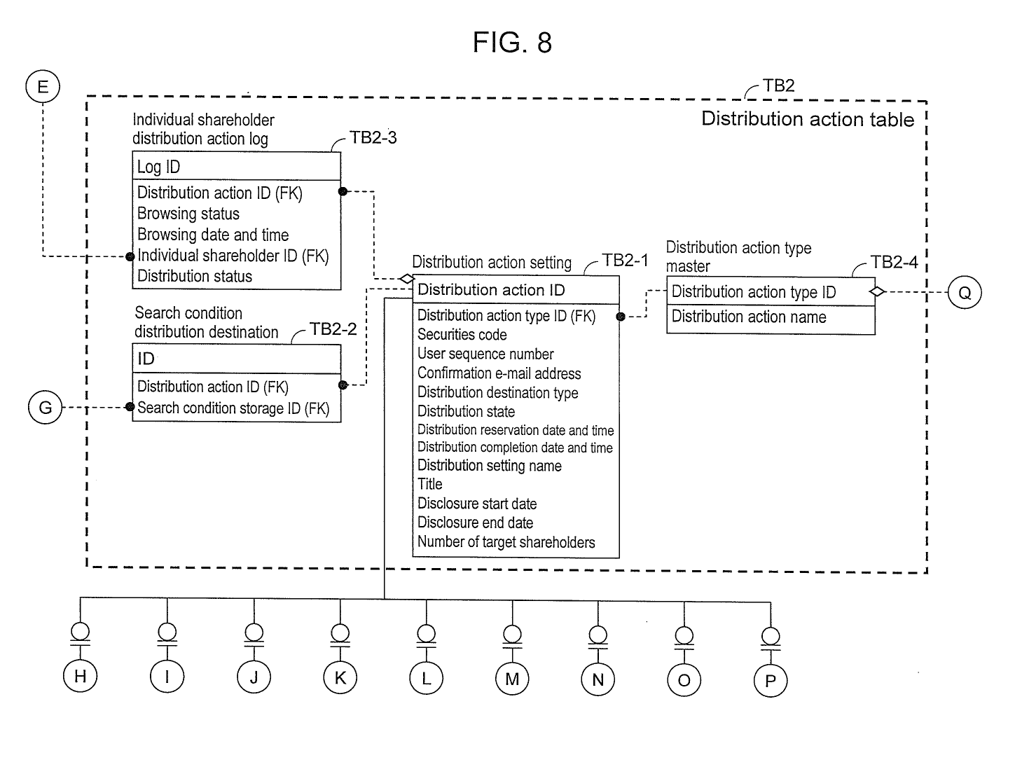

As illustrated in FIG. 8, The distribution action table group TB2 includes a distribution action setting table TB2-1, a search condition distribution destination table TB2-2, an individual shareholder distribution action log table TB2-3, and a distribution action type master table TB2-4.

The distribution action setting table TB2-1 includes, for each distribution action ID, a distribution action type ID, a securities code, a user sequence number, a confirmation e-mail address, a distribution destination type, a distribution state, distribution reservation date and time, distribution completion date and time, a distribution setting name, a title, a disclosure start date, a disclosure end date, and the number of target shareholders.

The search condition distribution destination table TB2-2 includes a distribution action ID and a search condition saving ID.

The individual shareholder distribution action log table TB2-3 includes, for each log ID, a distribution action ID, a browsing status, browsing date and time, an individual shareholder ID, and a distribution status.

The distribution action type master table TB2-4 includes a distribution action type ID and a distribution action name.

Here, the association between the tables is described. The distribution action setting table TB2-1 is associated with the search condition distribution destination table TB2-2 by the distribution action ID, associated with the individual shareholder distribution action log table TB2-3 by the distribution action ID, and associated with the distribution action type master table TB2-4 by the distribution action type ID. In addition, the individual shareholder distribution action log table TB2-3 is associated with the individual shareholder table TB1-3 by the individual shareholder ID.

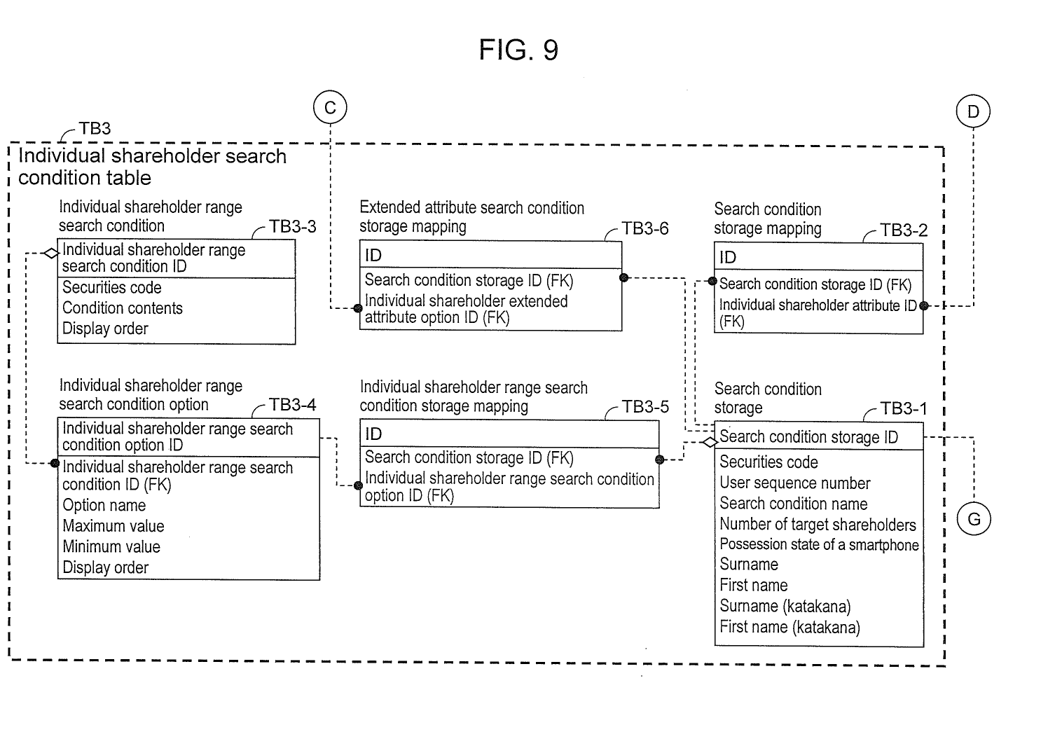

As illustrated in FIG. 9, the individual shareholder search condition table group TB3 includes a search condition saving table TB3-1, a search condition saving mapping table TB3-2, an individual shareholder range search condition table TB3-3, an individual shareholder range search condition option table TB3-4, an individual shareholder range search condition saving mapping table TB3-5, and an extended attribute search condition saving mapping table TB3-6.

The search condition saving table TB3-1 includes, for each search condition saving ID, a securities code, a user sequence number, a search condition name, the number of target shareholders, a possession state of a smartphone, surname, first name, surname (katakana), first name (katakana), as an item.

The search condition saving mapping table TB3-2 includes a search condition saving ID and an individual shareholder attribute ID.

The individual shareholder range search condition TB3-3 includes, for each individual shareholder range search condition ID, a securities code, a condition contents, and a display order.

The individual shareholder range search condition option table TB3-4 includes, for each individual shareholder range search condition option ID, an individual shareholder range search condition ID, an option name, a maximum value, a minimum value, and a display order.

The individual shareholder range search condition saving mapping table TB3-5 includes, a search condition saving ID and an individual shareholder range search condition option ID.

The extended attribute search condition saving mapping table TB3-6 includes a search condition saving ID and an individual shareholder extended attribute option ID.

Here, the association between the tables is described. The search condition saving table TB3-1 is associated with the search condition saving mapping table TB3-2 by the search condition saving ID, and associated with the individual shareholder range search condition saving mapping table TB3-5 by the search condition saving ID. The individual shareholder range search condition option table TB3-4 is associated with the individual shareholder range search condition saving mapping table TB3-5 by the individual shareholder range search condition option ID. In addition, the search condition saving mapping table TB3-2 is associated with the individual shareholder attribute table TB1-12 by the individual shareholder attribute ID, the search condition saving table TB3-1 is associated with the search condition distribution destination table TB2-2 by the search condition saving ID, and the extended attribute search condition saving mapping table TB3-6 is associated with the individual shareholder extended attribute option table TB1-5 by the individual shareholder extended attribute option ID.

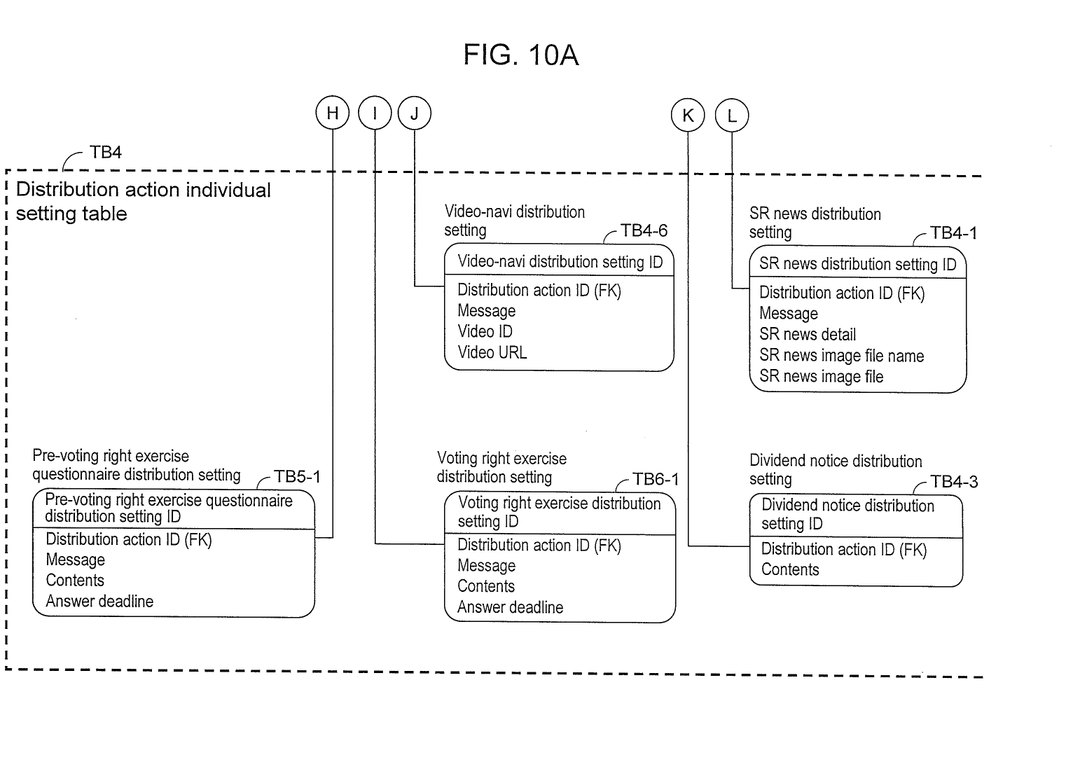

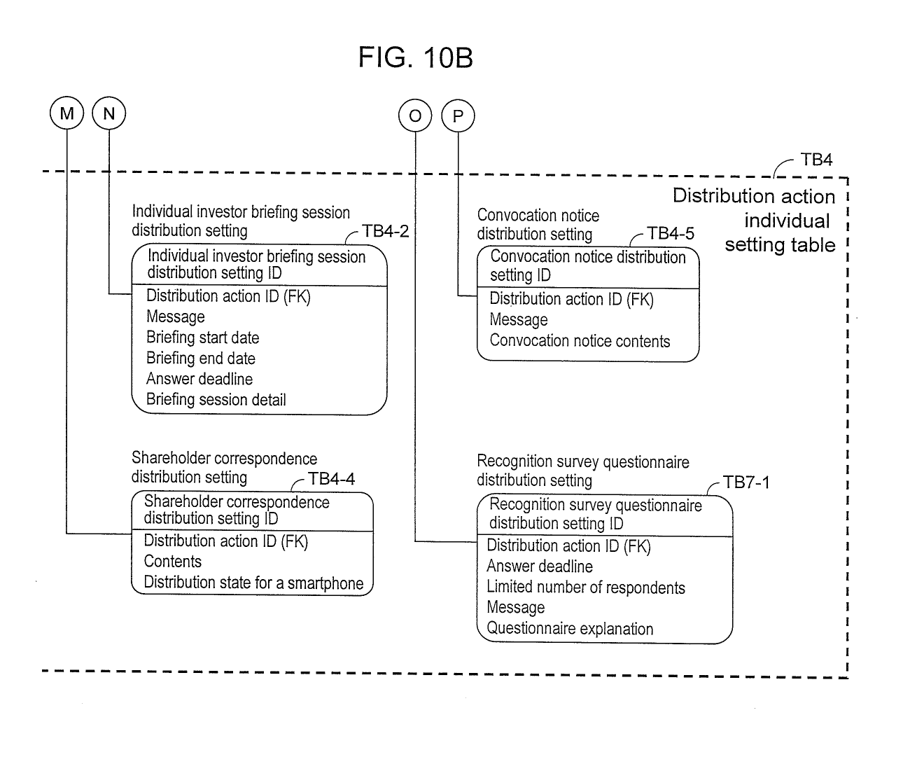

As illustrated in FIGS. 10A and 10B, the distribution action individual setting table group TB4 includes an SR news distribution setting table TB4-1, an individual investor briefing session distribution setting table TB4-2, a dividend notice distribution setting table TB4-3, a shareholder correspondence distribution setting table TB4-4, a convocation notice distribution setting table TB4-5, and a video-navi distribution setting table TB4-6, and includes a pre-voting right exercise questionnaire distribution setting table TB5-1, a voting right exercise distribution setting table TB6-1, and a recognition survey questionnaire distribution setting table TB7-1, as a common table with another table group described later.

The SR news distribution setting table TB4-1 includes a distribution action ID, a message, an SR news detail, an SR news image file name, and an SR news image file.

The individual investor briefing session distribution setting table TB4-2 includes, for each individual investor briefing session distribution setting ID, a distribution action ID, a message, a briefing start date, a briefing end date, an answer deadline, and a briefing session detail.

The dividend notice distribution setting table TB4-3 includes, for each dividend notice distribution setting ID, a distribution action ID and contents.

The shareholder correspondence distribution setting table TB4-4 includes, for each shareholder correspondence distribution setting ID, a distribution action ID, contents, and distribution state for a smartphone.

The convocation notice distribution setting table TB4-5 includes, for each convocation notice distribution setting ID, a distribution action ID, a message, and convocation notice contents.

The video-navi distribution setting table TB4-6 includes, for each video-navi distribution setting ID, a distribution action ID, a message, a video ID, and a video URL.

In addition, the SR news distribution setting table TB4-1 to the video-navi distribution setting table TB4-6 are connected to the distribution action setting table TB2-1.

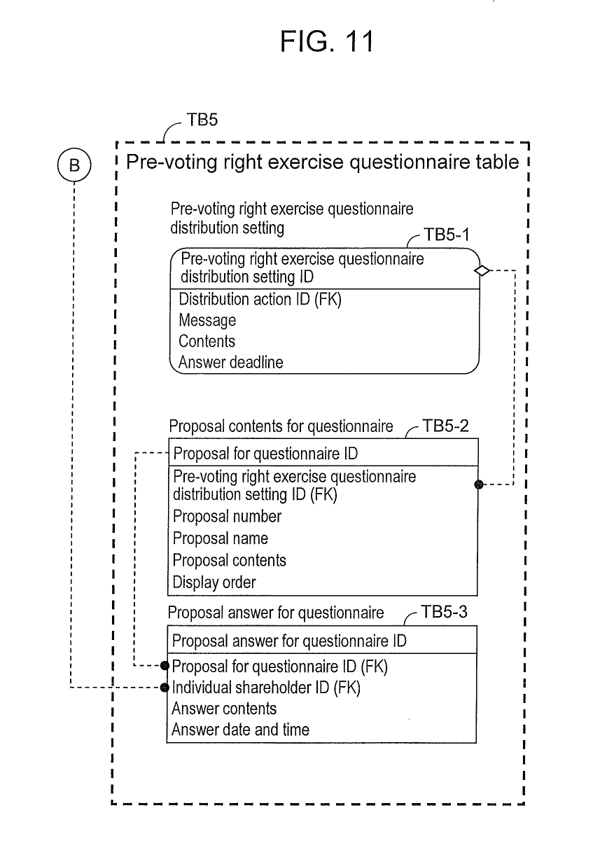

As illustrated in FIG. 11, the pre-voting right exercise questionnaire table group TB5 includes the pre-voting right exercise questionnaire distribution setting table TB5-1, a proposal content for questionnaire table TB5-2, and a proposal answer for questionnaire table TB5-3.

The pre-voting right exercise questionnaire distribution setting table TB5-1 includes, for each pre-voting right exercise questionnaire distribution setting ID, a distribution action ID, a message, contents, and answer deadline.

The proposal content for questionnaire table TB5-2 includes, for each proposal for questionnaire ID, a pre-voting right exercise questionnaire distribution setting ID, a proposal number, a proposal name, proposal contents, and a display order.

The proposal answer for questionnaire table TB5-3 includes, for each proposal answer for questionnaire ID, a proposal for questionnaire ID, an individual shareholder ID, answer contents, and answer date and time.

Here, the pre-voting right exercise questionnaire distribution setting table TB5-1 is associated with the distribution action setting table TB2-1, and associated with the proposal contents for questionnaire table TB5-2, and the proposal contents for questionnaire table TB5-2 is associated with the proposal answer for questionnaire table TB5-3.

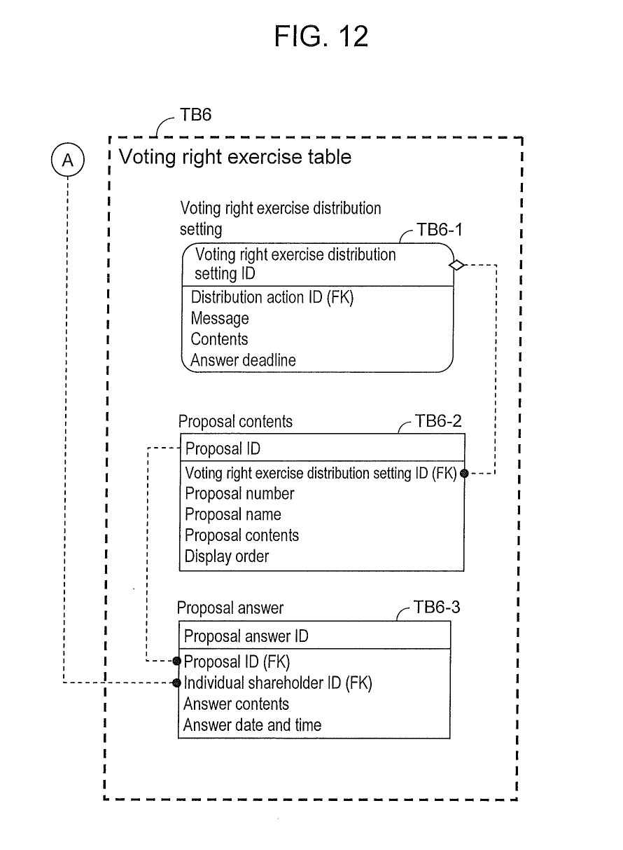

As illustrated in FIG. 12, the voting right exercise table group TB6 includes the voting right exercise distribution setting table TB6-1, a proposal content table TB6-2, and a proposal answer table TB6-3.

The voting right exercise distribution setting table TB6-1 includes, for each voting right exercise distribution setting ID, a distribution action ID, a message, contents, and answer deadline.

The proposal content table TB6-2 includes, for each proposal ID, a voting right exercise distribution setting ID, a proposal number, a proposal name, proposal contents, and a display order.

The proposal answer table TB6-3 includes, for each proposal answer ID, a proposal ID, an individual shareholder ID, answer contents, and answer date and time. The TB6-1, the TB6-2, and the TB6-3 are associated with each other, and the TB6-3 is associated with the individual shareholder table TB1-3. In addition, the voting right exercise distribution setting table TB6-1 is associated with the distribution action setting table TB2-1 by the distribution action ID.

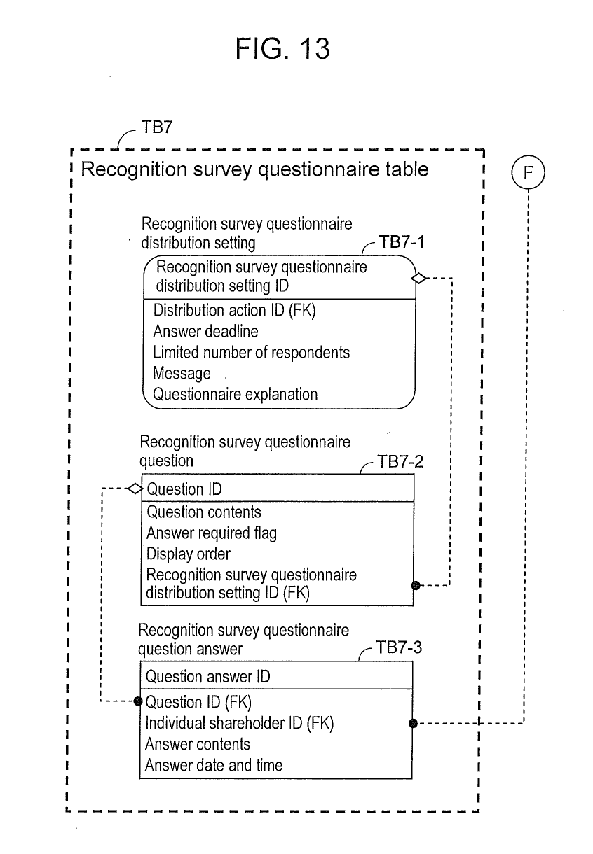

As illustrated in FIG. 13, the recognition survey questionnaire table group TB7 includes the recognition survey questionnaire distribution setting table TB7-1, a recognition survey questionnaire question table TB7-2, and a recognition survey questionnaire question answer table TB7-3.

The recognition survey questionnaire distribution setting table TB7-1 includes, for each recognition survey questionnaire distribution setting ID, a distribution action ID, an answer deadline, the limited number of respondents, and questionnaire explanation as an item, the recognition survey questionnaire question table TB7-2 includes, for each question ID, question contents, an answer required flag, a display order, and a recognition survey questionnaire distribution setting ID, and the recognition survey questionnaire question answer table TB7-3 includes, for each question answer ID, a question ID, an individual shareholder ID, answer contents, and answer date and time. The TB7-1, the TB7-2, and the TB7-3 are associated with each other, the recognition survey questionnaire distribution setting table TB7-1 is associated with the distribution action setting table TB2-1, and the recognition survey questionnaire question answer table TB7-3 is associated with the individual shareholder table TB1-3.

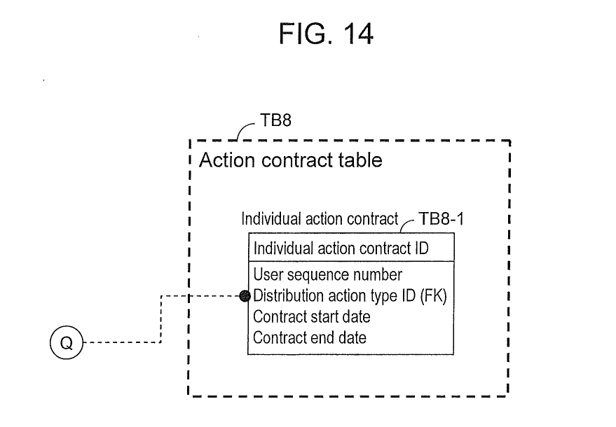

As illustrated in FIG. 14, the action contract table group TB8 includes an individual action contract table TB8-1, and the table includes, for each individual action contract ID, a user sequence number, a distribution action type ID, a contract start date, and a contract end date. The individual action contract table TB8-1 is associated with the distribution action type master table TB2-4 by the distribution action type ID.

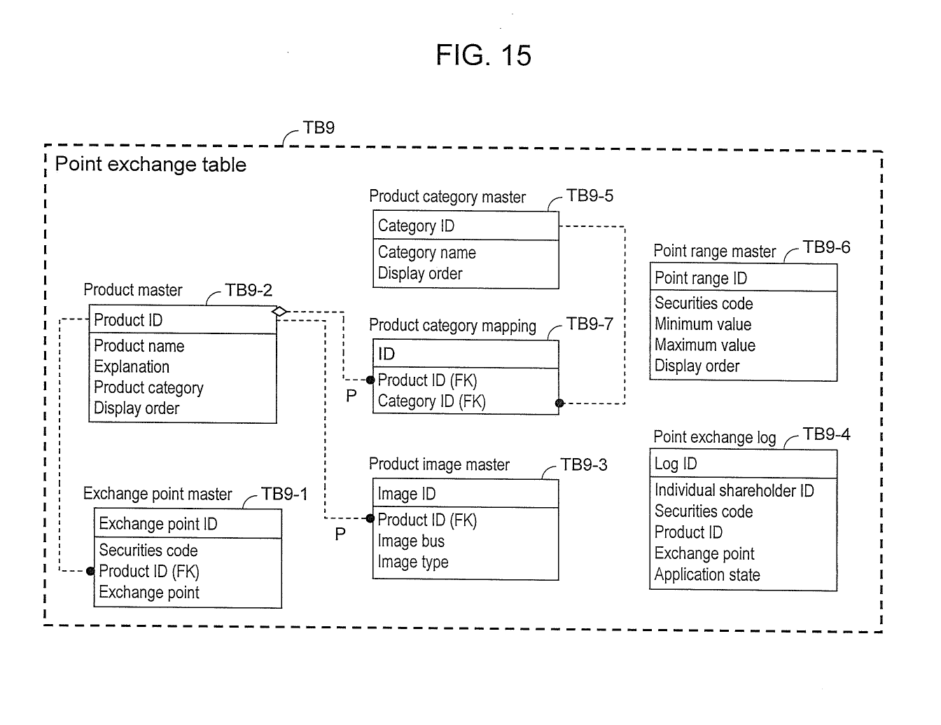

As illustrated in FIG. 15, the point exchange table group TB9 include an exchange point master table TB9-1, a product master table TB9-2, a product image master table TB9-3, a point exchange log table TB9-4, a product category master table TB9-5, a point range master table TB9-6, and a product category mapping table TB9-7.

The exchange point master table TB9-1 includes, for each exchange point ID, a securities code, a product ID, and an exchange point.

The product master table TB9-2 includes, for each product ID, a product name, explanation, a product category, and a display order.

The product image master table TB9-3 include, for each image ID, a product ID, an image bus, and an image type.

The point exchange log table TB9-4 includes, for each log ID, an individual shareholder ID, a securities code, a product ID, an exchange point, and an application state.

The product category master table TB9-5 includes, for each category ID, a category name and a display order.

The point range master table TB9-6 includes, for each point range ID, a securities code, a minimum value, a maximum value, and a display order.

The product category mapping table TB9-7 includes a product ID and a category ID.

The product master table TB9-2 is associated with the product image master table TB9-3 by the product ID, and associated with the product category mapping table TB9-7 by the product ID.

An individual investor user has one ID for the whole SR functions in “individual shareholder” table. A shareholding status for each corporation is managed using the “individual shareholder corporate attribute”. Even when the individual investor user holds shares in two or more corporations, the individual investor can perform login using the unified ID/password in individual basis. In addition, for each corporation, in order to perform management by customizing shareholder attributes, the shareholder attributes is stored in the three tables related to “individual shareholder corporate extended attribute” (TB1-4 to TB1-6). The corporation can store a search condition of the corporation's individual shareholder (that includes a browsing member) (in the six tables related to the “individual shareholder search condition” (TB1-4 to TB1-6, TB1-11, TB1-12, and TB1-14)). The corporation can perform, for a shareholder, an action using the stored search condition. However, the performance of the action can be carried out only by a contract corporation that is registered to the corporate side shareholder information management server. In addition, the action is managed using the “distribution action” table, and a disclosure start date and a disclosure end date can be specified for the action. In addition, a product for point exchange can be managed. The whole products are managed in the “product master” table, and an exchange product can be customized for each of the contract corporations in the “exchange point master” table.

Next, operations of the shareholder management system according to the embodiment of the present invention is described with reference to a display screen, a transition diagram, a table configuration diagram, etc., as appropriate.

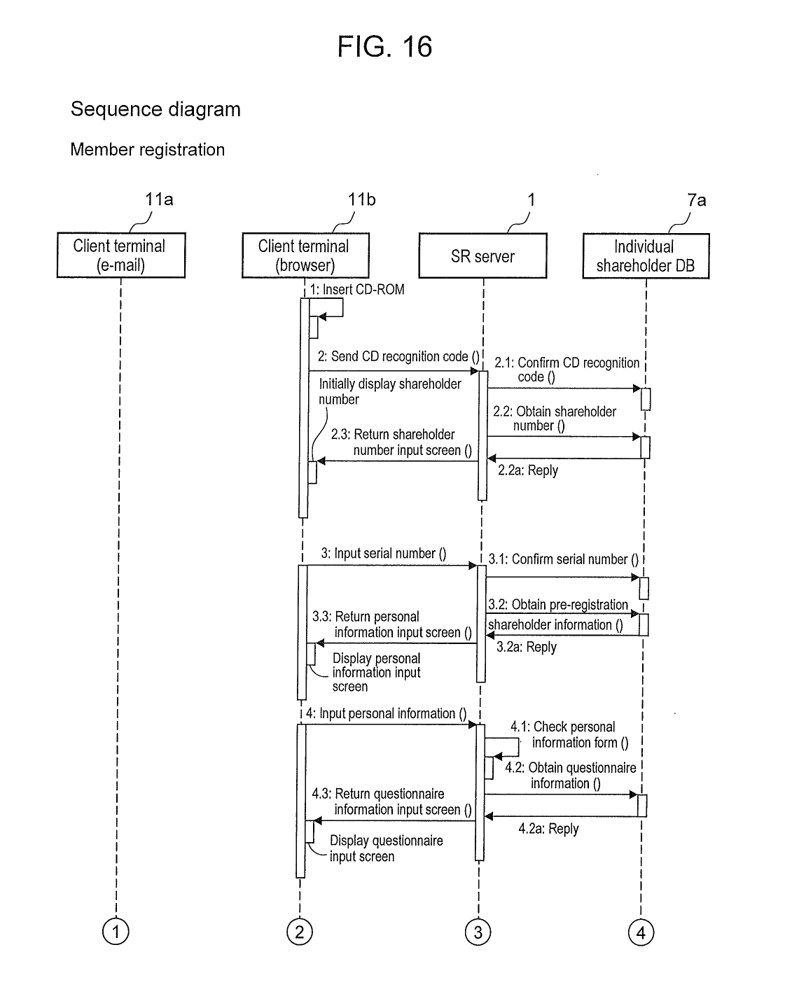

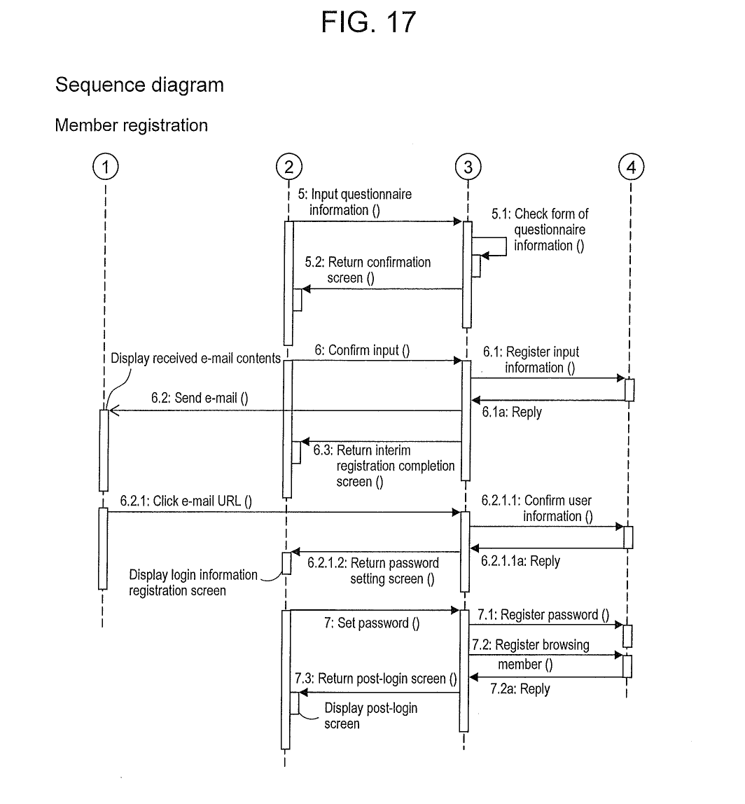

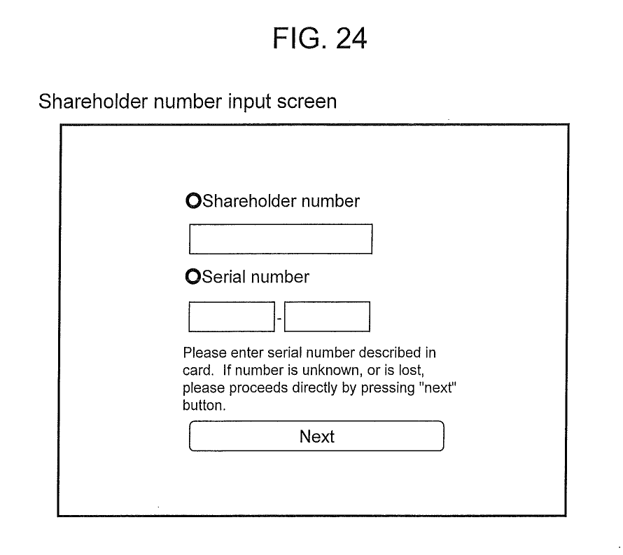

First, a member registration process is described with reference to sequence diagrams in FIGS. 16 and 17. First, the client terminal (browser) 11b reads the contents of a compact disc-read-only memory (CD-ROM) when the CD-ROM is inserted into the client terminal 11b (1 in FIG. 16). For example, as illustrated in FIG. 23, the CD is enclosed in a shareholder correspondence or sent as a direct mail (DM), and the CD received by a shareholder is inserted to a PC or a QR code, etc. on the enclosed medium is read by a mobile phone. After that, a CD authentication code is sent to an SR server 1, and the SR server 1 confirms the CD authentication code with the individual shareholder DB 7a (2.1 in FIG. 16). In the individual shareholder DB 7a, for example, using a storage medium unique ID item of the storage medium log table TB1-1 as a key, a latest shareholder number of the individual shareholder corporate attribute table TB1-2 is obtained (2.2 in FIG. 16). The latest shareholder number is replied to the SR server 1 (2.2a), an access number input screen is provided from the SR server 1 to the client terminal 11b, and the screen as illustrated in FIG. 24 is displayed. Here, for example, the latest shareholder number (that is initially displayed) is displayed, an interface to which a serial number (for example, the serial number is printed on a card enclosed with a CD package) can be input is displayed.

When the serial number is input (3 in FIG. 16), the serial number is sent to the SR server 1. The SR server 1 confirms the serial number with the individual shareholder DB 7a. In this case, the serial number of the storage medium log table TB1-1 is verified (3.1). When the verification succeeds, the SR server 1 issues an obtaining request of pre-registration shareholder information to the individual shareholder DB 7a and can obtain a given item of the related two tables of the individual shareholder corporate attribute table TB1-2 and the individual shareholder table TB1-3 from the individual shareholder DB 7a using data of the storage medium log table TB1-1 (3.2 and 3.2a).

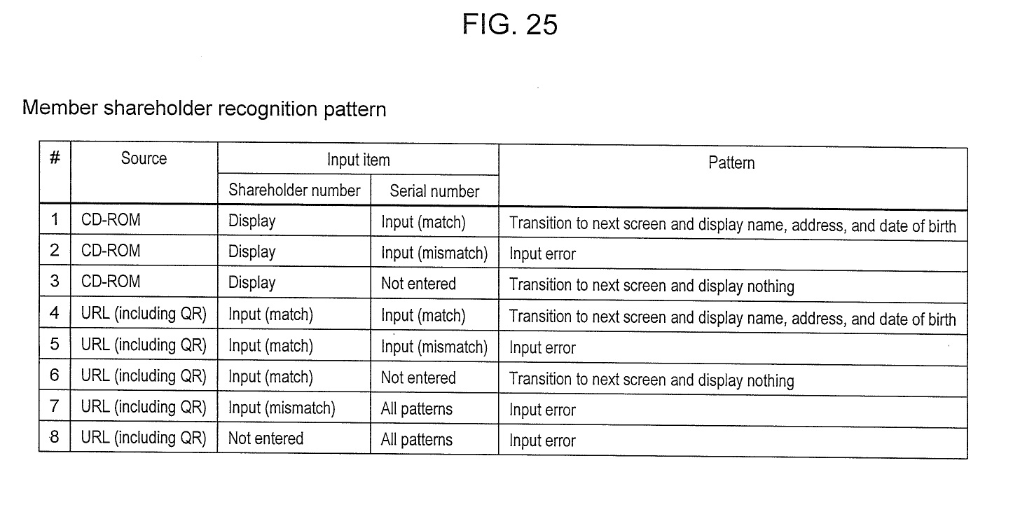

The SR server 1 returns a personal information input screen to the client terminal 11b. FIG. 25 is a diagram illustrating an example of a pattern in which personal information is displayed when a member shareholder is registered. Basically, only when a CD-ROM is started and a shareholder number and a serial number all match is the personal information displayed as the confirmation (the first line in the pattern). The same is true of a QR code (the fourth line in the pattern).

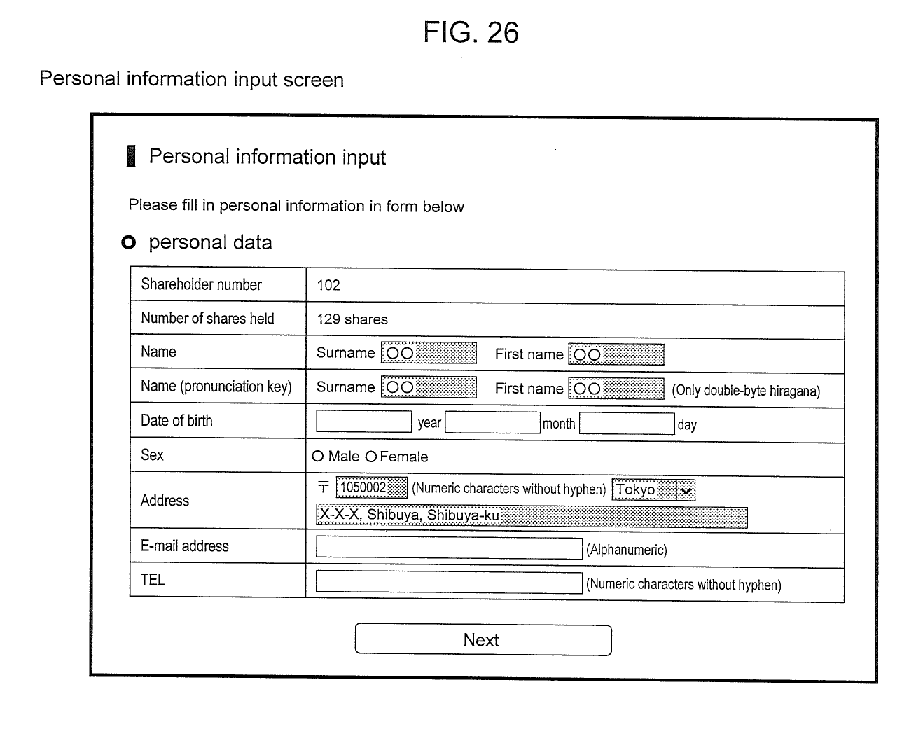

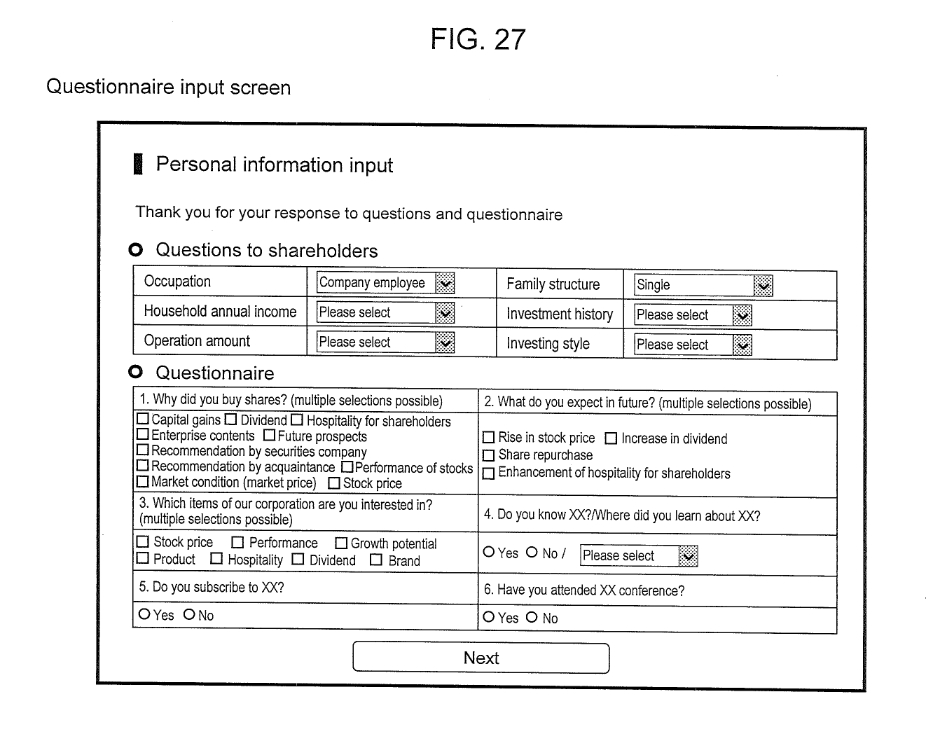

FIG. 26 is a diagram illustrating a display example of a personal information input screen. Here, as an input item of the user, for example, an e-mail address, a telephone number, date of birth, etc. may be input because name, name (pronunciation key), an address are registered beforehand. Here, when the personal information is input (4 in FIG. 16), the format of the personal information is checked (4.1 in FIG. 16). After that an obtaining request of questionnaire information is issued from the SR server 1 to the individual shareholder DB 7a (4.2 in FIG. 16), and using a securities code of the individual shareholder corporate attribute table TB1-2 as a key, pieces of data of the individual shareholder corporate extended attribute table TB1-4 and the individual shareholder extended attribute option table TB1-5 are obtained. In addition, the pieces of data for questionnaire information are replied to the SR server 1. The SR server 1 returns the questionnaire information input screen to the client terminal 11b, and in the client terminal 11b, a screen for questionnaire input illustrated in FIG. 27 is displayed. Here, questionnaire on a shareholder is input. A questionnaire item includes a reason why the user bought shares, expectation of future, and question on degree of familiarity of a server operating company in addition to occupation, family structure, household annual income, investment history, an operation amount, and an investing style, etc.

In addition, as illustrated in FIG. 17, when an input on the questionnaire item is performed from the client terminal 11b, the input is sent to the SR server 1 (5 in FIG. 17). In the SR server 1, questionnaire information format check is performed (5.1), and data for displaying a confirmation screen is sent to the client terminal 11b (5.2).

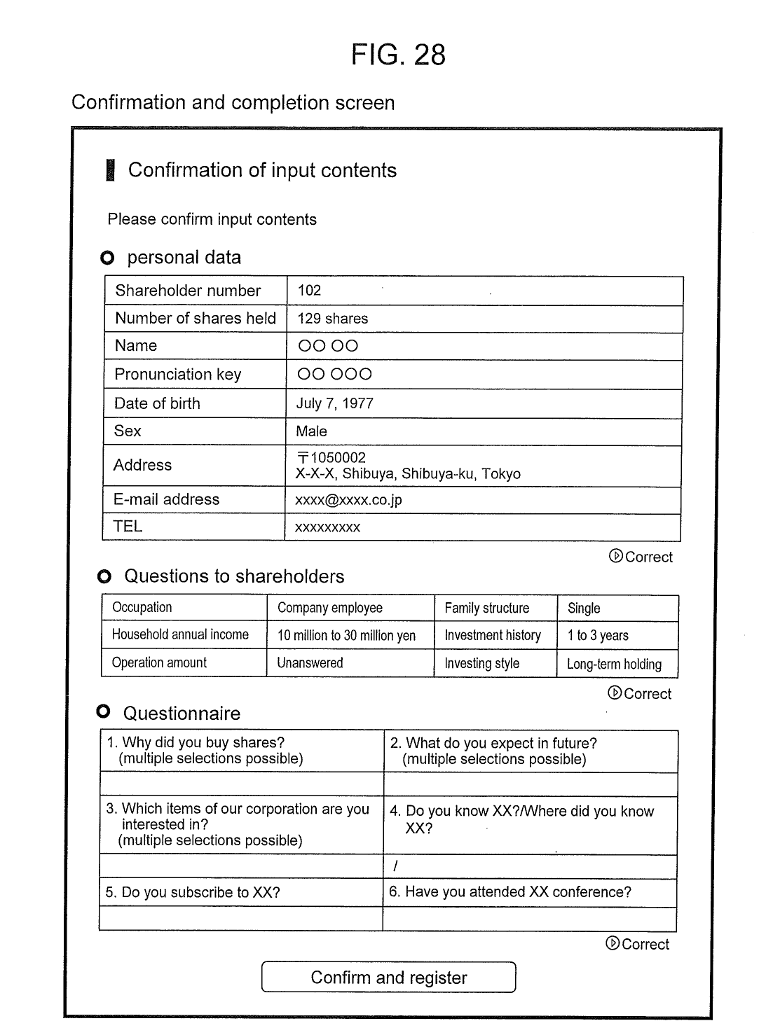

FIG. 28 is a diagram illustrating an example of an input confirmation screen of personal information and questionnaire and a screen for indicating the completion. As illustrated in FIG. 28, on the confirmation screen of input contents, the input individual data, answer data on the question to the shareholder, questionnaire data, etc. are displayed, and a button for prompting registration after the confirmation is displayed. When the button is pressed, data of the input confirmation is sent from the client terminal 11b to the SR server 1 (6 in FIG. 17), and the input information from the SR server 1 is registered to the individual shareholder DB (6.1 in FIG. 17). In this case, the pieces of data until the sequence 4 in the individual shareholder table TB1-3, the individual shareholder corporate attribute table TB1-2, and the individual shareholder corporate extended attribute answer table TB1-6 are updated, and a temporary key for registration confirmation is registered to the timed key table TB1-7. In addition, the reply to the SR server 1 is performed (6.1a), and a received content display e-mail is sent to the client terminal (e-mail) 11a (6.2). In this case, a URL into which the created temporary key in the sequence of 6.1 is incorporated is inserted into the body of the e-mail to send the e-mail. FIG. 30 is a diagram illustrating an example of an e-mail with a URL for completing the registration. Here, it is displayed on the e-mail that the registration is completed by accessing the URL. Through a link of the URL, the user can access the URL.

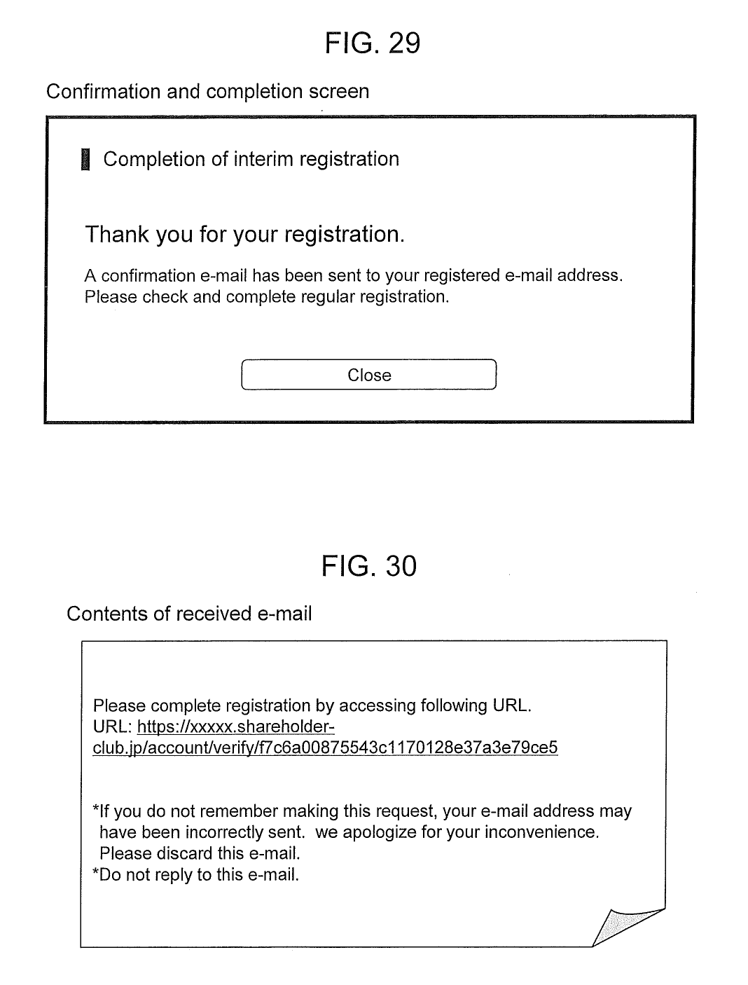

In addition, an interim registration completion screen is returned from the SR server 1 to the client terminal 11b (6.3), and as illustrated in FIG. 29, on the interim registration completion screen, a message for indicating that a confirmation e-mail is sent to the registered e-mail address and a message for prompting the registration after the confirmation are displayed.

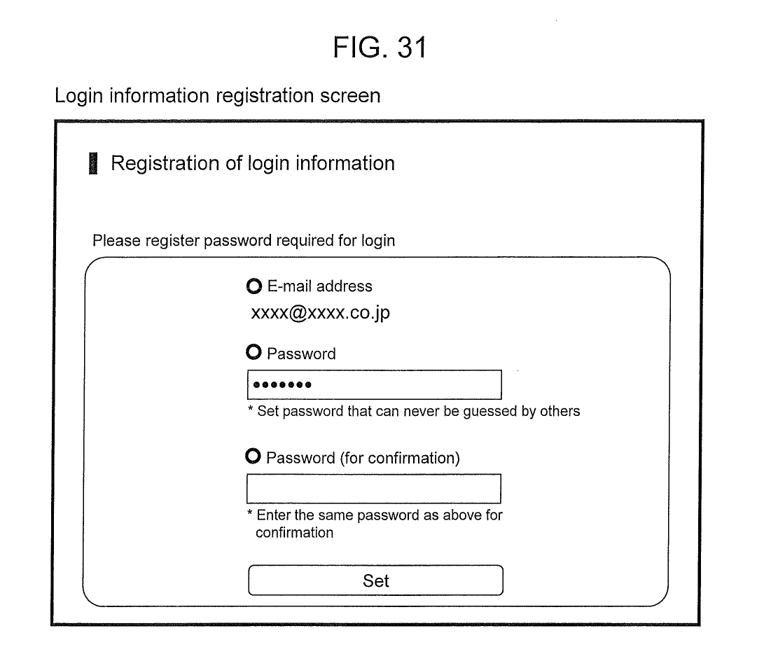

When the user sees the display and clicks a URL in a screen illustrated in FIG. 30, in response to the click, the SR server 1 sends data for confirming user information to the individual shareholder DB 7a (6.2.1.1), the temporary key created in the above-described sequence of 6.1 is extracted from the URL, the timed key table TB1-7 is searched, and the related item of the individual shareholder table TB1-3 is obtained. In addition, the item is replied to the SR server 1 (6.2.1.1a). The SR server 1 sends a password setting screen to the client terminal 11b (6.2.1.2), and a login information registration screen illustrated in FIG. 31 is displayed. Here, the e-mail address and a field for inputting a password are displayed, a button for performing setting after a password is input is also displayed. Here, when the user inputs a password, the password is sent to the SR server 1 (7), and the SR server 1 registers the password to the shareholder DB 7a (7.1). Here, the password item of the individual shareholder table TB1-3 is updated. In addition, when an instruction of regular member registration (7.2) is issued from the SR server 1, the member status item of the individual shareholder corporate attribute table TB1-2 is updated, the update is replied to the SR server 1 (7.2a), the SR server 1 returns a post-login screen to the client terminal 11a (7.3), and the post-login screen is displayed.

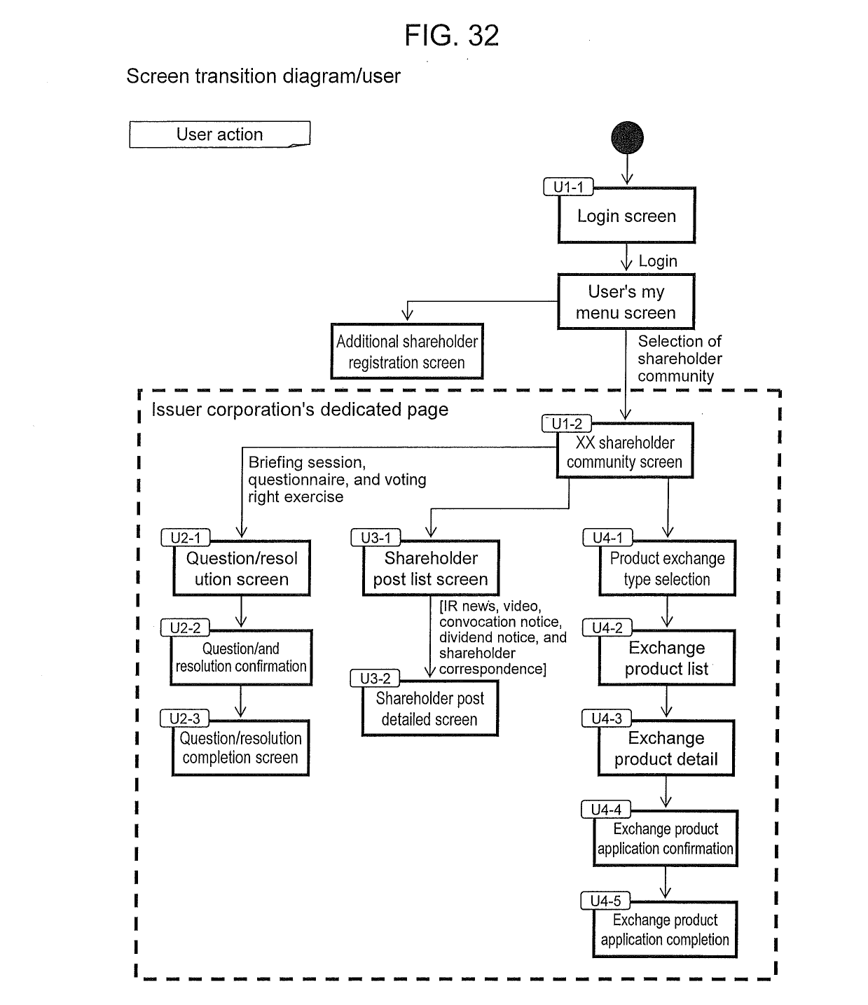

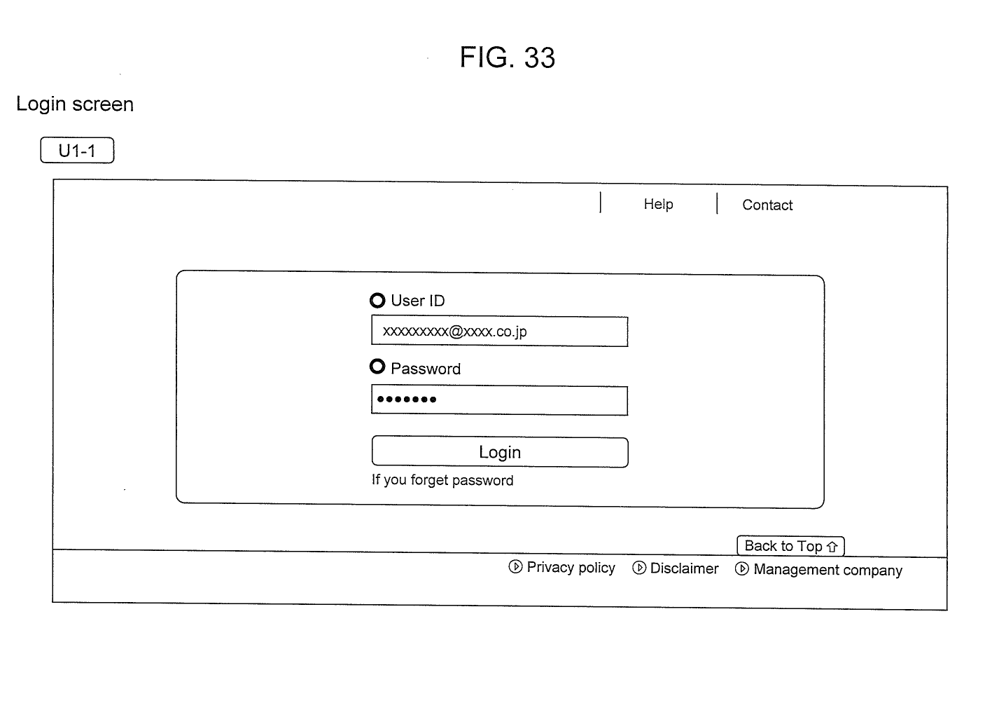

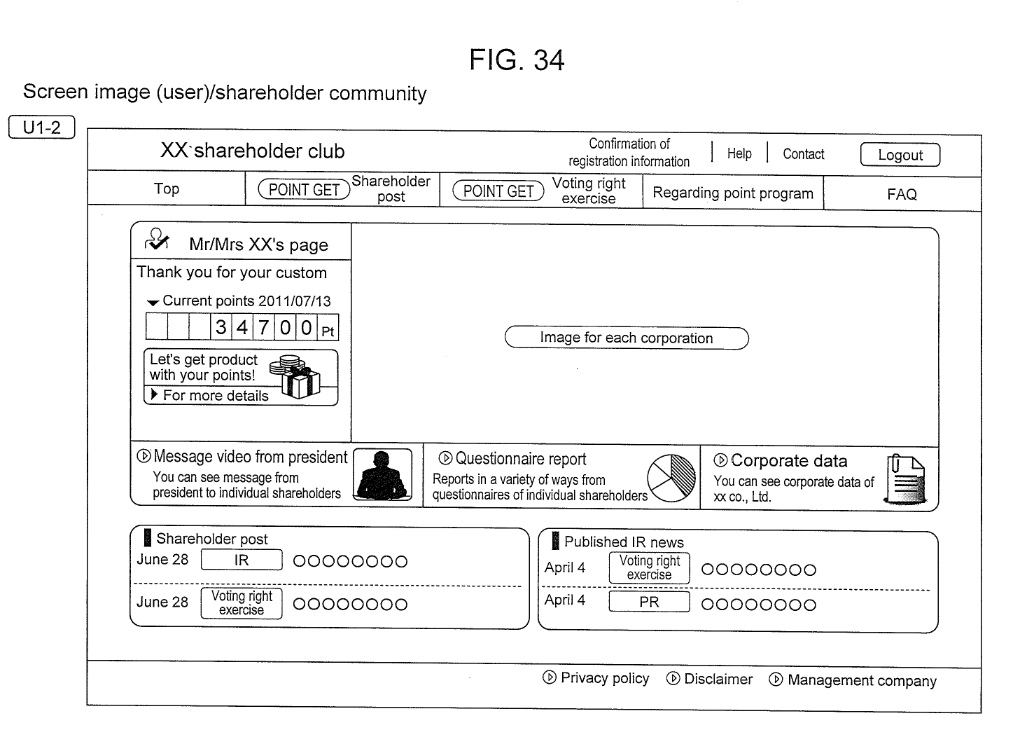

In this way, the member registration is completed. The member registration is performed as above-described regular member. FIG. 32 is a schematic view illustrating a screen transition example of user action from the SR server 1. As illustrated in FIG. 32, the whole login screen as the SR server 1 is displayed. FIG. 33 is a diagram illustrating a display example of the login screen (U1-1). As illustrated in FIG. 33, on the login screen, a user ID and an input screen for a password are displayed, and the login can be performed when the user inputs the items (the login screen in FIG. 32). When the login is performed, a shareholder community to which the user belongs is displayed (see FIG. 34). For example, a shareholder post, voting right exercise, a point program, Q&A, the number of current points, another piece of information (menu) are displayed as menus.

From here, the screen can transition to an additional shareholder registration screen. On the other hand, when a desired shareholder community is selected, a “XX shareholder community screen” is displayed (U1-2). Hereinafter, a dedicated page of an issuer corporation is described. Here, when the procedure proceeds to a briefing session described later, questionnaire, and voting right exercise, the screen proceeds a question/resolution screen (U2-1), a question/resolution answer confirmation screen (U2-2), a question/resolution answer completion screen (U2-3) in order. In addition, after the screen proceeds from the “XX shareholder community screen” (U1-2) to a shareholder post list screen (U3-1), the screen proceeds to a shareholder post detailed screen in which IR news, a video, a convocation notice, a dividend notice, shareholder correspondence are available as menus (U3-2). In addition, after the screen proceeds from the “XX shareholder community screen” (U1-2) to an exchange product type selection screen (U4-1), the screens proceeds to an exchange product list display (U4-2), an exchange product detail (U4-3), an exchange product application confirmation (U4-4), and an exchange product application completion (U4-5) in order (see below for details). As described above, when the login is performed, various actions can be selected and performed.

A flow of the detailed process is described below.

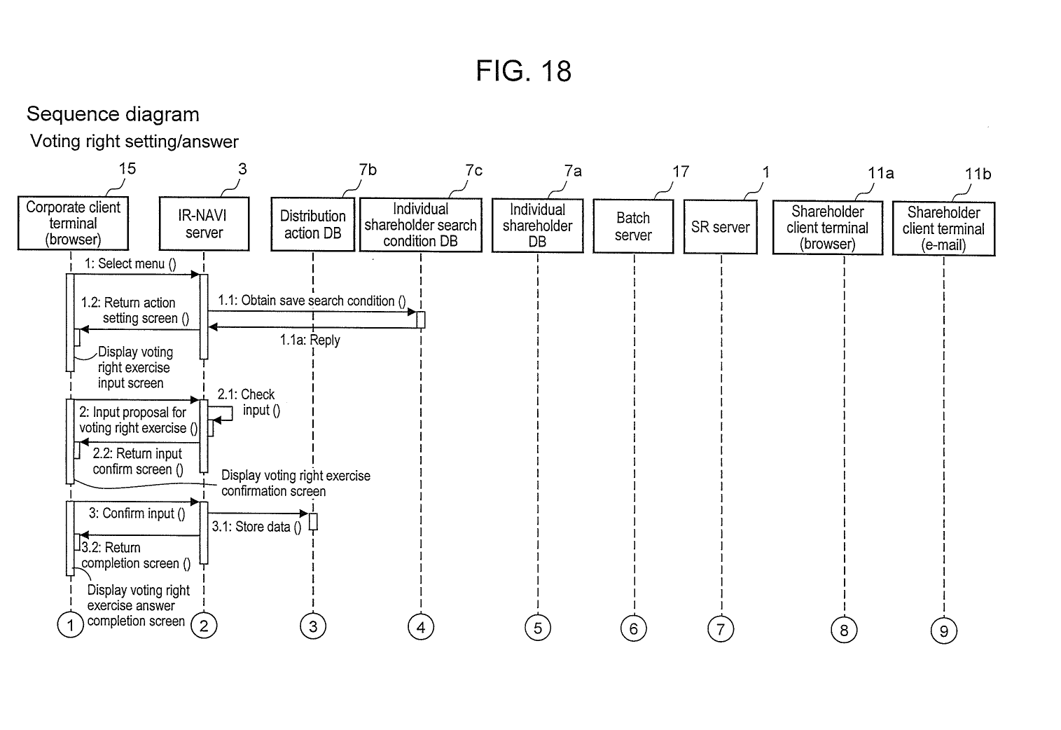

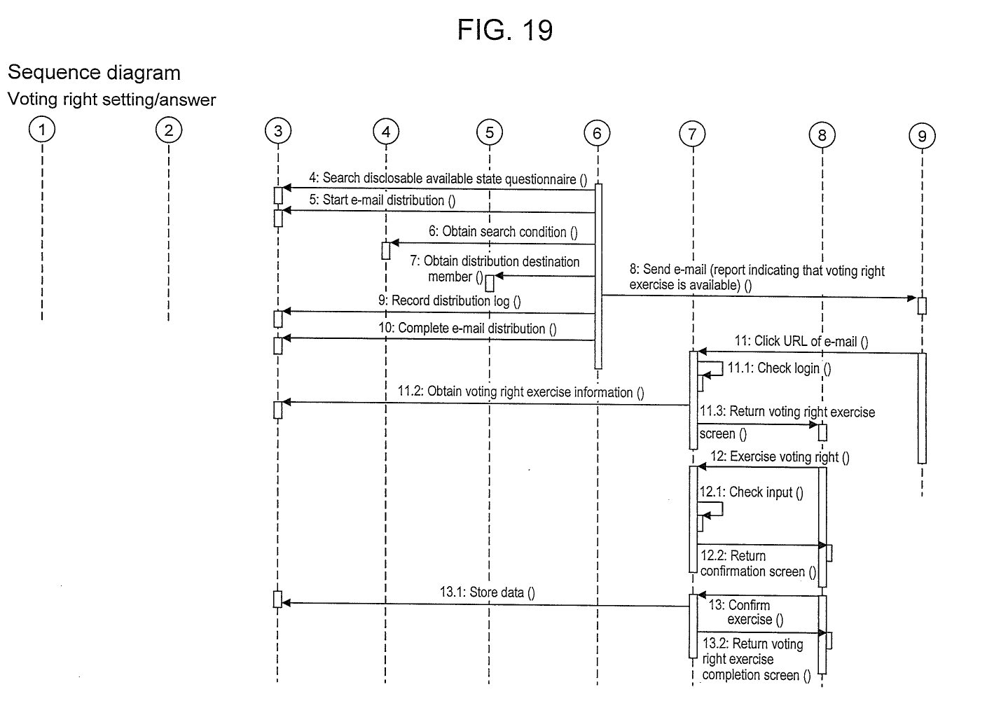

First, a voting right setting/answer process is described (FIGS. 18 and 19).

As illustrated in FIGS. 18 and 19, in a voting right setting/answer process of proposal of shareholders' meeting, etc., first, when the member registration is performed as the above-described regular member, voting right exercise can be performed through the system. In the system, the SR server 1, the batch server 17, the individual shareholder DB 7a, an individual shareholder search condition DB 7c, a distribution action DB 7b, the IR-navi server 3, the corporate client terminal 15, the shareholder client terminal (browser) 11a, the shareholder client terminal (e-mail) 11b are provided.

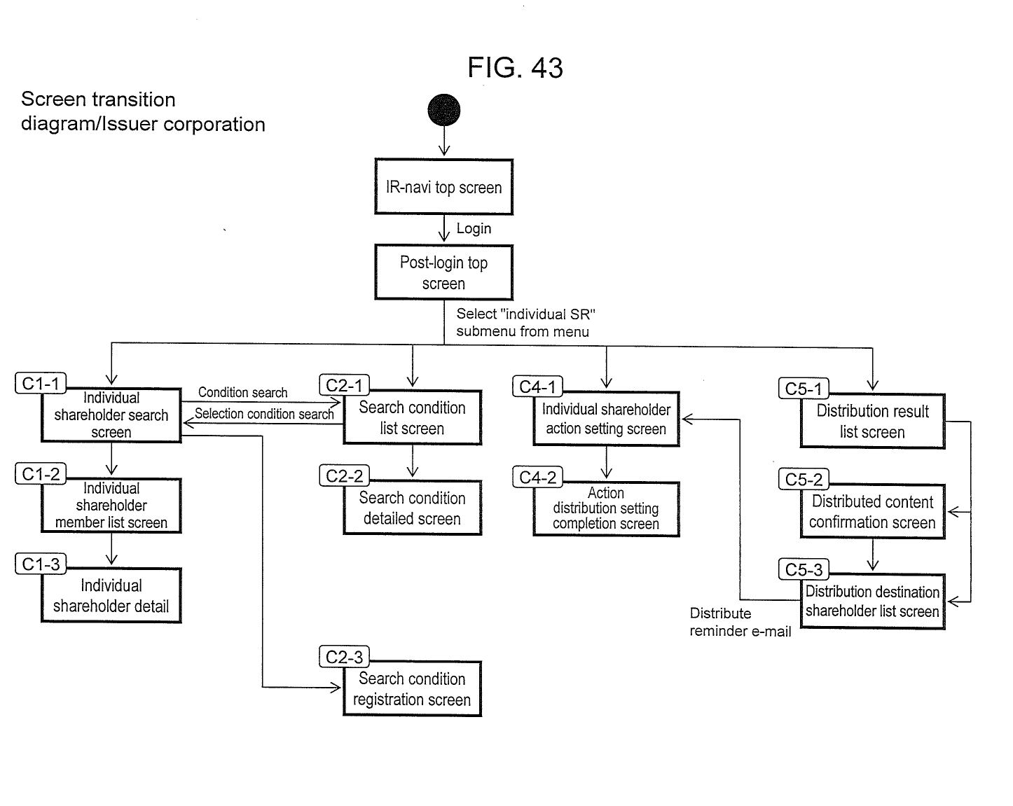

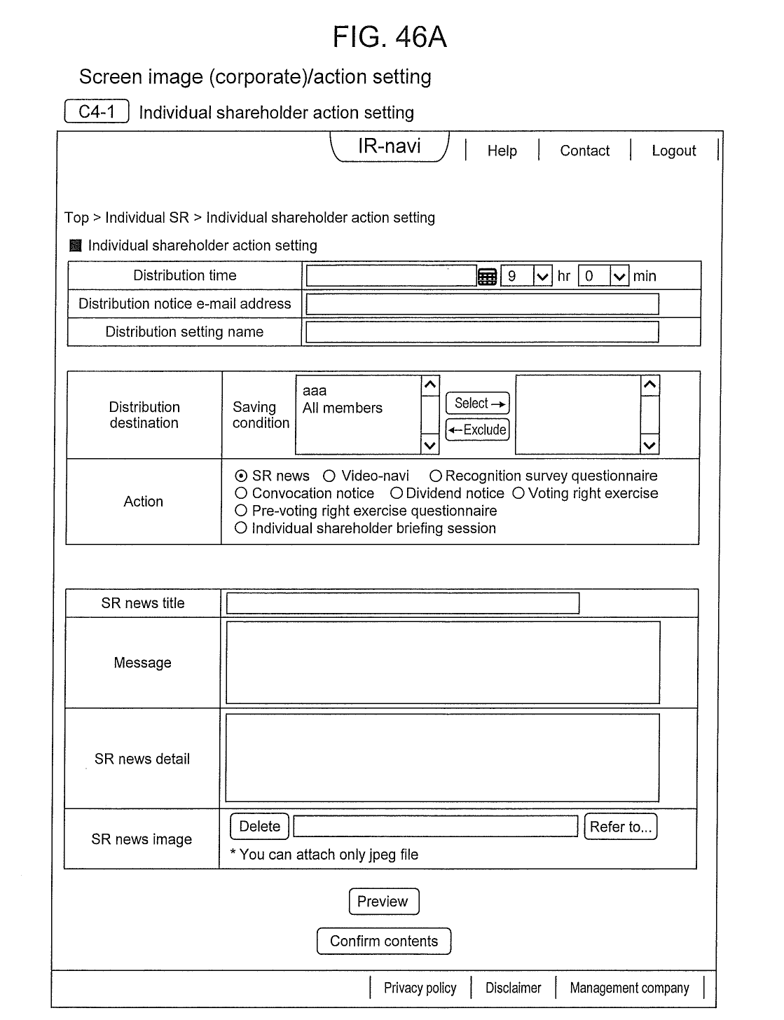

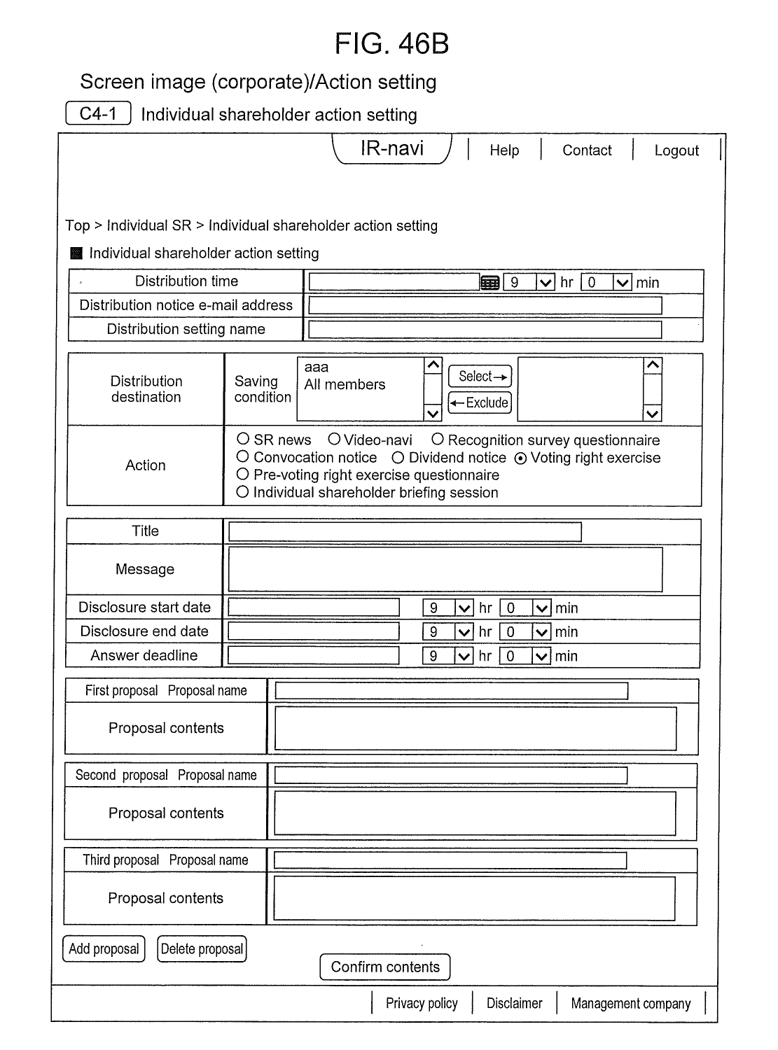

Here, FIG. 43 is a screen transition diagram of an issuer corporation by the IR-navi. As illustrated in FIG. 43, a person in charge of the issuer corporation performs login from a top screen of the IR-navi, and the screen transitions to a top screen after the login. Here, when a menu is selected from the corporate client terminal 15 (1), the instruction is sent to the IR-navi server 3. Here, the IR-navi server 3 issues an obtaining request of a save search condition to the individual shareholder search condition DB 7c (1.1). Using a securities code of the login corporation as a key, data of the search condition saving table TB3-1 is obtained, and the data is replied to the IR-navi server 3 (1.1a). The IR-navi server 3 returns information of an action setting screen to the corporate client terminal 15 (1.2). Here, on the corporate client terminal 15, for example, a voting right exercise setting screen (FIG. 46B) is displayed, and a proceeding input for voting right exercise is performed to the IR-navi server 3 (2) to perform input check (2.1). In addition, an input confirmation screen is returned from the IR-navi server 3 (2.2). Here, on the corporate client terminal 15, a voting right exercise screen is displayed, and an instruction of input confirmation is issued from the corporate client terminal 15 to the IR-navi server 3 (3).

An instruction of data storage is issued from the IR-navi server 3 to the distribution action DB 7b (3.1). In response to the instruction, data is newly registered to the distribution action setting table TB2-1, the search condition distribution destination table TB2-2, the voting right exercise distribution setting table TB6-1, and the proposal content table TB6-2. In response to the reply to the new registration, a completion screen is returned from the IR-navi server 3 to the corporate client terminal 15 (3.2).

Next, the batch server 17 that includes the information processing unit 17a and the communication unit 17b issues an instruction of disclosable state questionnaire search to the distribution action DB 7b, and data that is available for voting right exercise is searched for. In the start of regular batch, an item of the distribution action setting table TB2-1 is searched for under the following condition (4). The condition is that scheduled distribution date and time is earlier than the batch start time and that the distribution state is “distribution reservation”. Next, e-mail distribution starts (5). In this case, the item of the distribution state of the data searched for in the above-described (4) is updated during the distribution. Next, the batch server 17 issues an obtaining request of a search condition to the individual shareholder search condition DB 7c (6). Here, 1) the search condition distribution destination table TB2-2 is searched by the item of the distribution action ID of the distribution action setting table TB2-1 obtained in the above-described (4), the item of a search condition ID is obtained. 2) data of the search condition saving table TB3-1 is obtained by the above-described obtained item, and in order to build a search condition, pieces of data are obtained from the search condition saving mapping table TB3-2, the individual shareholder range search condition table TB3-3, the individual shareholder range search condition option table TB3-4, the individual shareholder range search condition saving mapping table TB3-5, and the extended attribute search condition saving mapping table TB3-6.

Next, the batch server 17 issues an obtaining instruction of a distribution destination member to the individual shareholder DB 7a (7). Here, items such as an individual shareholder ID, a PC e-mail address, a mobile phone e-mail address, surname, and first name in the individual shareholder table TB1-3 of corresponding data are obtained by search of the individual shareholder table TB1-3, the individual shareholder corporate attribute table TB1-2, and the individual shareholder corporate extended attribute answer table TB1-6 under the search condition of the above-described (5).

In the above-described state, the batch server 17 performs e-mail sending (report that voting right exercise is available) to the shareholder client terminal (e-mail) 11b (8). In addition, the batch server 17 records a distribution log to the distribution action DB 7b (9), and here, data is sent to the individual shareholder distribution action ID table TB2-3 by the distribution action ID obtained in the above-described (4) and the individual shareholder ID obtained in the above-described (7). In addition, the batch server 17 performs sending of e-mail distribution completion (10). The batch server 17 sends an e-mail distribution completion notice to the distribution action DB 7c (10). Here, the distribution state item searched in the above-described (4) is update to a state in which the e-mail has been distributed.

In the shareholder client terminal (e-mail) 11b, clicking of a URL of an e-mail for the SR server 1 is performed (11), the login is checked (11.1), and the SR server 1 issues an obtaining request of voting right exercise information to the distribution action DB 7b (11.2). Here, 1) using individual shareholder data (individual shareholder ID) for the login as a key, data is obtained by search of the individual shareholder distribution action log table TB2-3. 2) using a distribution action ID that is a data item in the above-described 1) as a key, the distribution action table TB-2, the voting right exercise distribution setting table TB6-1, and the proposal content data table TB6-2 are obtained.

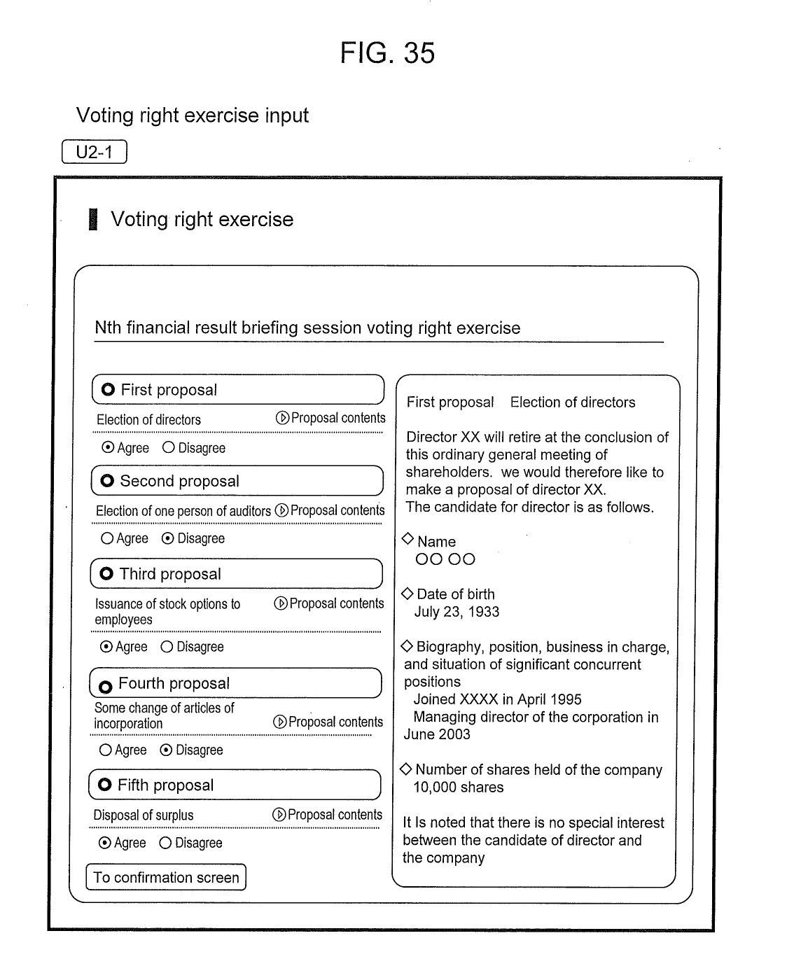

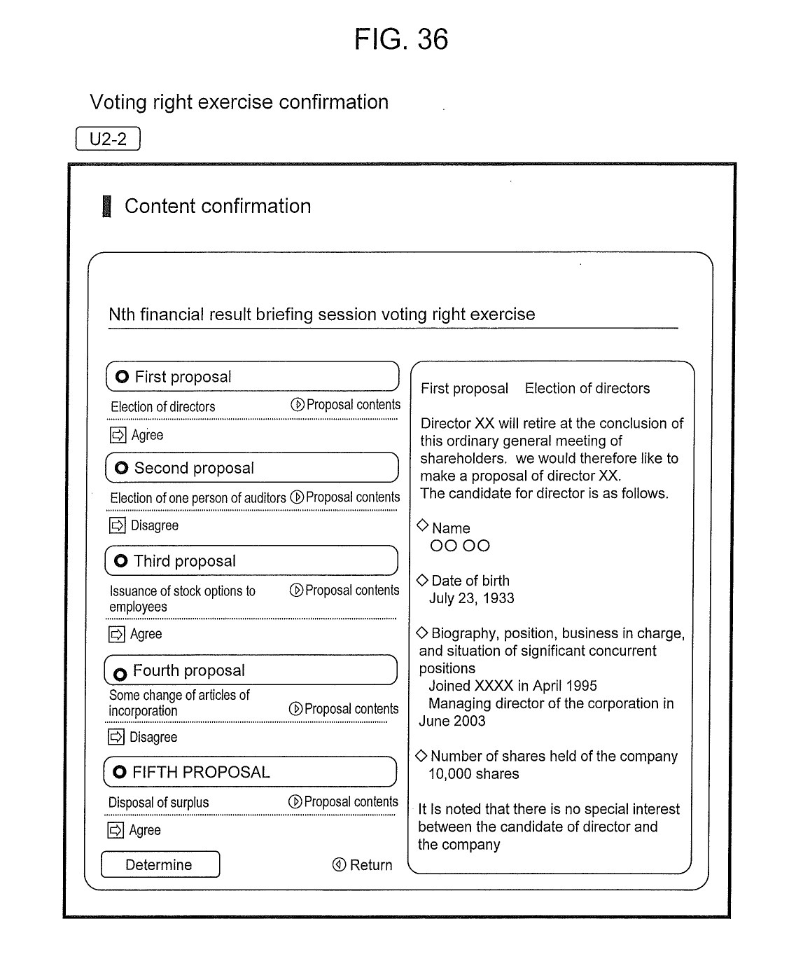

On the other hand, the SR server 1 returns a voting right exercise screen to the shareholder client terminal (browser) 11a (11.3), performs the screen display as illustrated in FIG. 35, and voting right exercise is performed through the screen as illustrated in FIG. 36 (12). As illustrated in FIG. 35, for example, voting right exercise of the Xth financial result briefing session is displayed, and the screen includes contents of the first proposal to the nth proposal, an agree/disagree checkbox, and a button for transitioning to a confirmation screen.

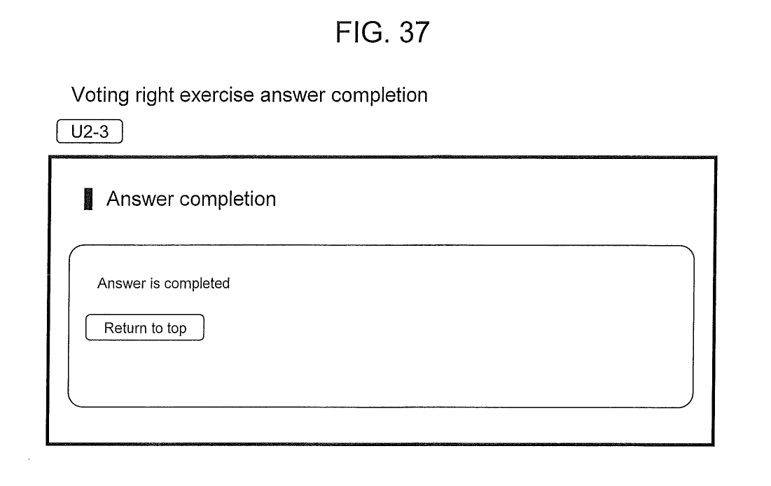

In the SR server 1, input check is performed, and a confirmation screen is returned from the SR server 1 to the shareholder client terminal 11a (12.2 in FIG. 36). The shareholder client terminal 11a issues a confirmation request of the exercise to the SR server 1 (13) and the SR server 1 issues a saving request of the data to the distribution action DB 7b (13.1). Here, the voting right exercise result input to the proposal answer table is registered (TB6-3). The SR server 1 returns a voting right exercise completion screen to the shareholder client terminal (browser) 11a (13.2, FIG. 37).

At last, the process of voting right exercise ends.

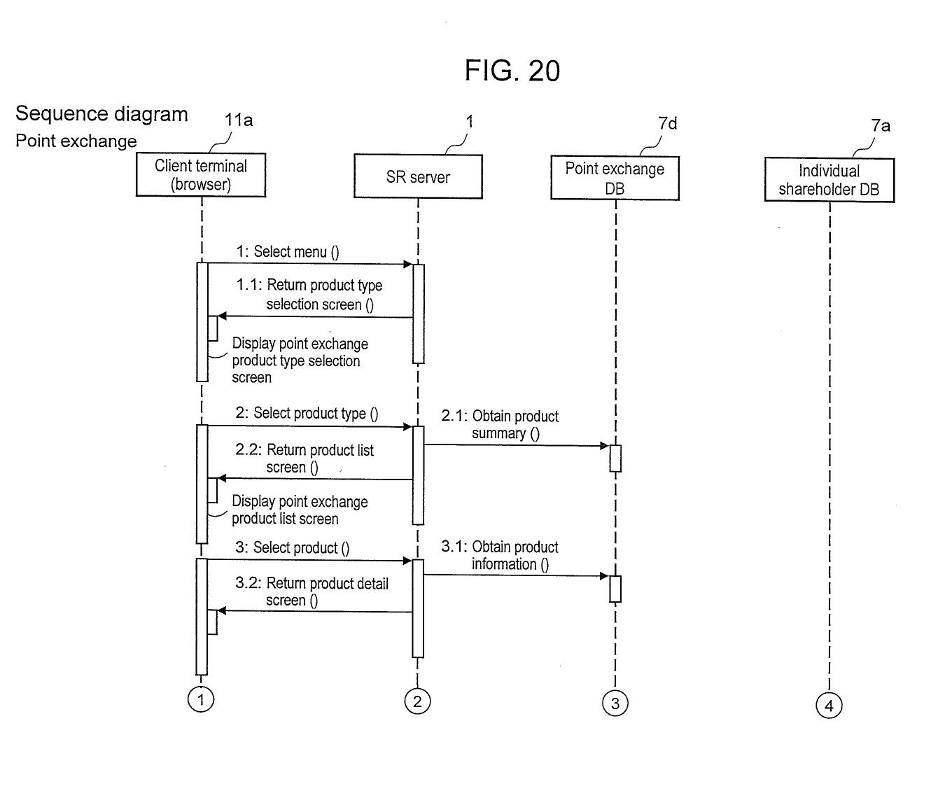

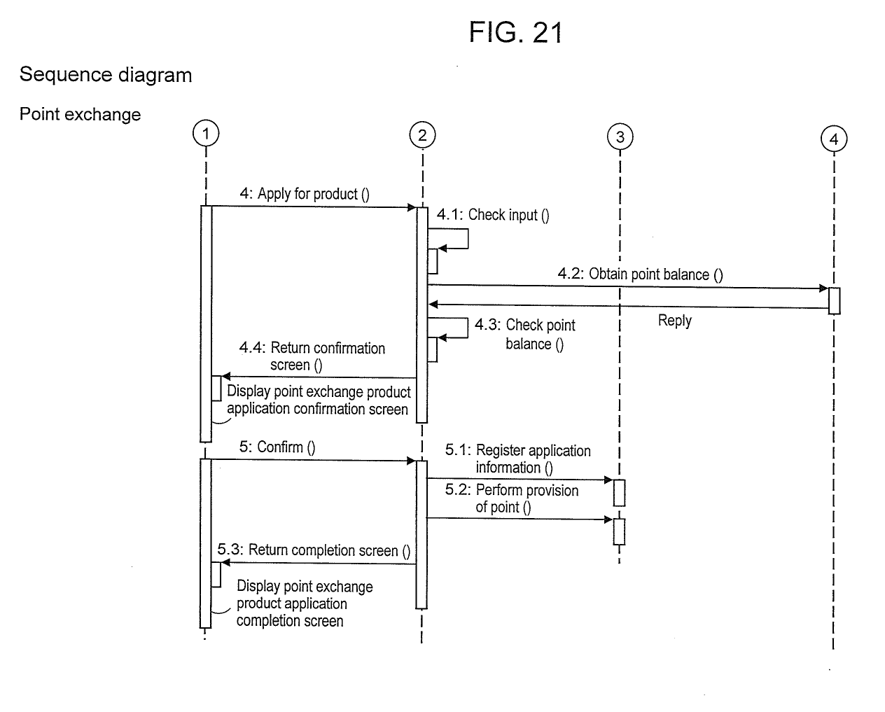

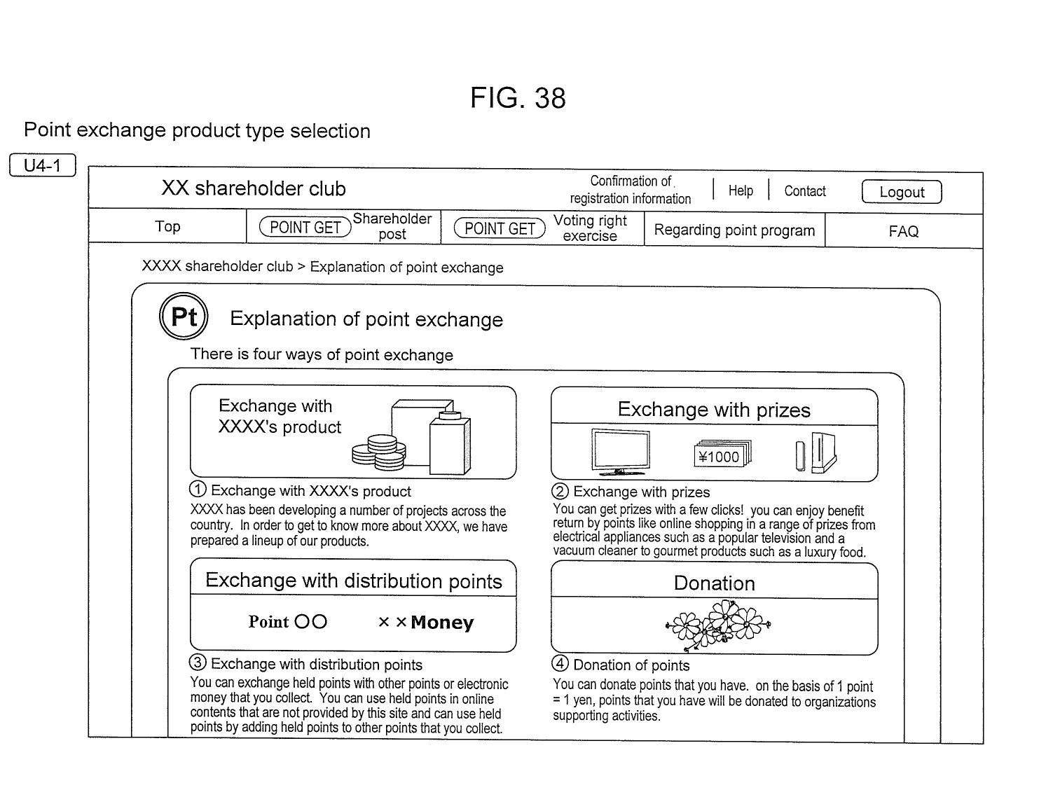

Next, a process of point exchange is described with reference to FIGS. 20 and 21. First, the login to the system is performed through the client terminal 11a, and when an instruction of the menu selection is sent to the SR server 1 (1), the SR server 1 returns a product type selection screen (1.1). Here, on the client terminal 11a, a point exchange product type selection screen illustrated in FIG. 38 is displayed. Here, the explanation of the point exchange is displayed. For example, the screen includes selection buttons such as an option of exchange of products of a corporation that holds shares, an option of exchange of another product, and an option of exchange with a circulation point and donation.

When the selection by the select button is performed, the selection is sent to the SR server 1 (2), a product summary obtaining request is sent to the point exchange DB 7d (2.1). Here, using a securities code of the shareholder club site target corporation and a product type (product category) selected in the above-described 1.1 as a key, the exchange point master table TB9-1, the product master table TB9-2, and the product image master table TB9-3 are obtained.

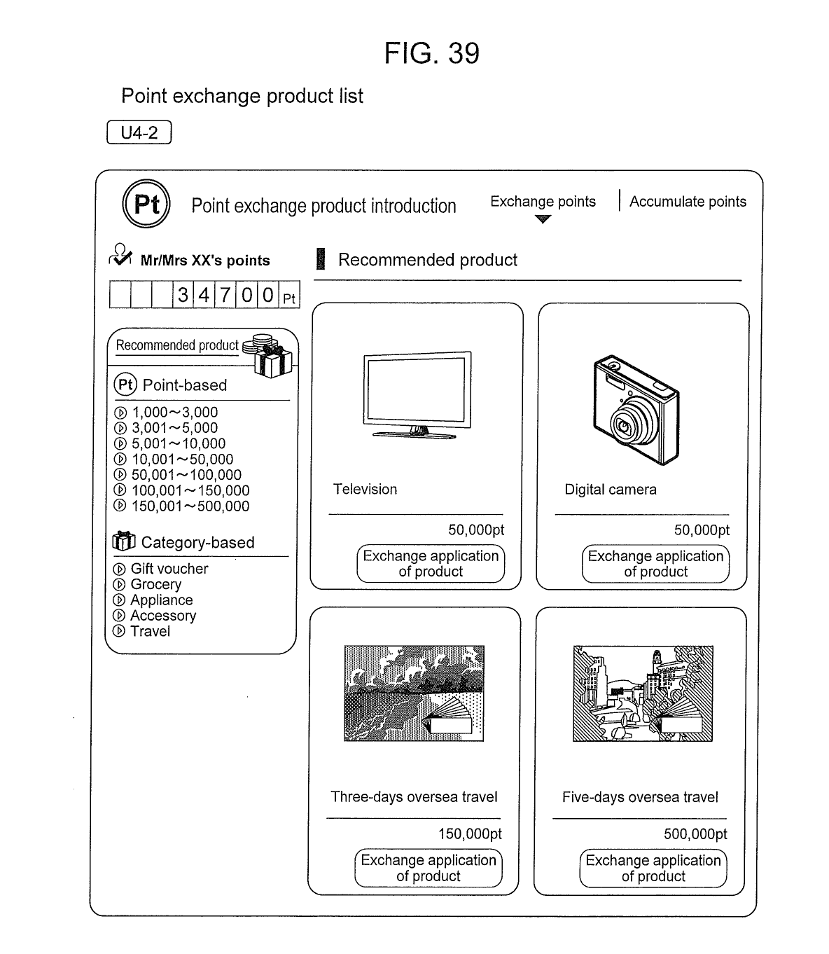

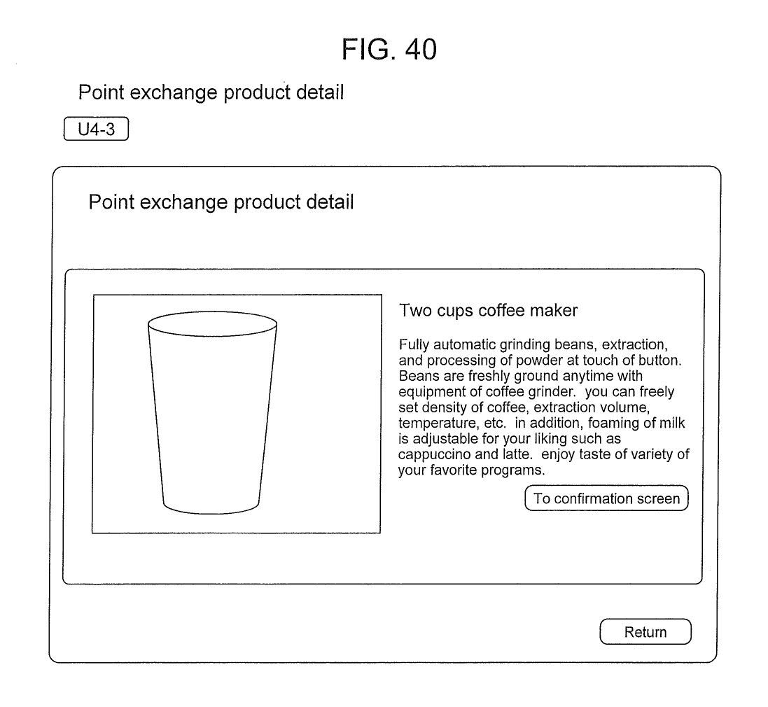

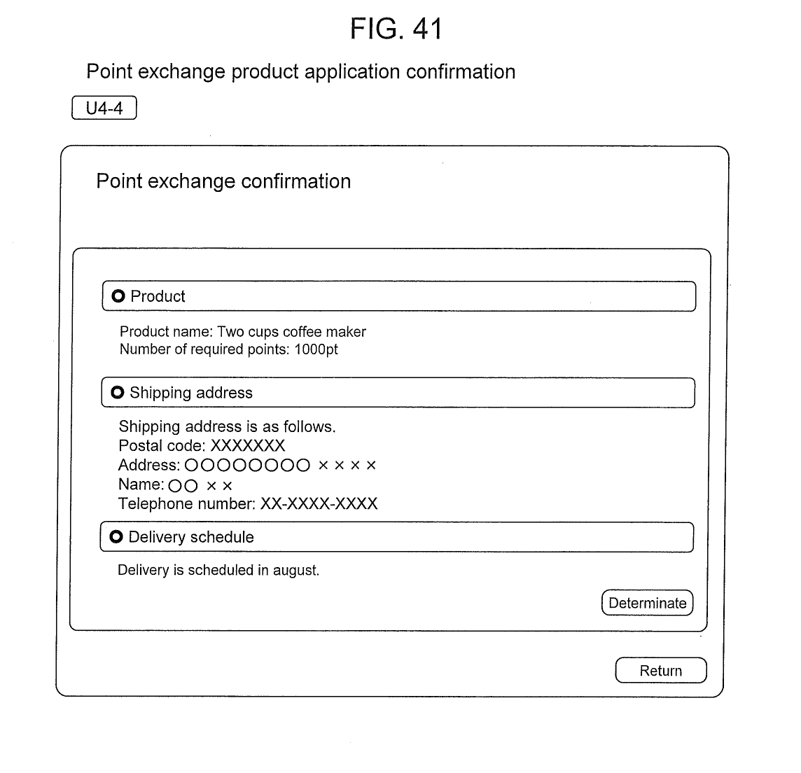

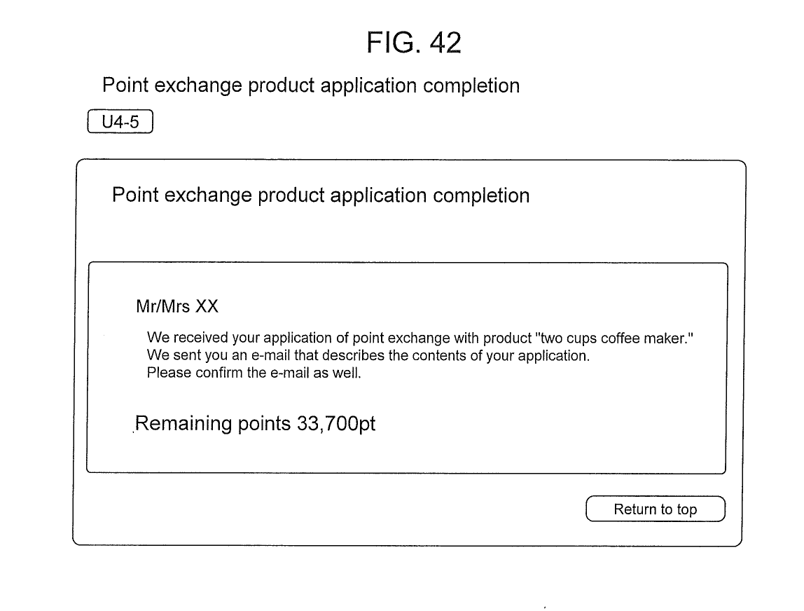

In addition, the SR server 1 returns a product list screen to the client terminal (browser) 11a (2.2), and a point exchange product list screen is displayed. FIG. 39 is a diagram illustrating an example of the point exchange product list screen. In FIG. 39, introduction of a point exchange product, the number of currently held points, and links, etc. for displaying a recommended product for each of the number of points are displayed, and as a recommended product, presents such as television, digital camera, and various travel tours are prepared. Here, when a product is selected (3), the SR server 1 issues a product information obtaining request to the point exchange DB 7d (3.1). In this case, using a product ID of the selected product as a key, data is obtained from the product master table TB9-2. When the data is returned, the SR server 1 returns a product detailed screen to the client terminal 11a (3.2). Here, on the client terminal 11a, the product detailed screen (FIG. 40) is displayed. FIG. 40 illustrates the detailed explanation of the point exchange product. The user can determine the selection of a product by using the explanation as guidance. From here, the screen can proceeds to a confirmation screen. When the application of a product is performed for the SR server 1 by the confirmation (4), input check is performed in the SR server 1 (4.1), and an obtaining request of point balance is issued to the individual shareholder DB 7a (4.2). Here, a number of held points that is the data item of the individual shareholder corporate attribute table TB1-2 of the login user is obtained (4.2). When the obtained data item is returned, the SR server 1 performs check of point balance (4.3) and returns a confirmation screen to the client terminal 11a (4.4). Here, the point exchange product application confirmation screen (FIG. 41) is displayed, and a product name, the number of desired points, shipping address, shipping schedule, etc. are displayed. In the confirmation screen, balance check is performed. When a confirmation (determination) button is pressed in the screen (5), the SR server 1 issues an instruction of application information registration to the point exchange DB 7d (5.1), and performs the provision of used points (5.2). Here, new registration to the point exchange log table TB9-4 is performed, and the number of held points of the individual shareholder corporate attribute table TB1-2 is recalculated and updated. In addition, the SR server 1 returns a completion screen to the client terminal 11a (5.3), and the point exchange completion screen is displayed (see FIG. 42). Here, a notice for reporting that the product is sent and the number of remaining points are displayed.

At last, the point exchange process ends. By the point exchange process, the shareholder can obtain a desired product using held points, thereby providing an incentive for using the system, for the shareholder. In addition, the corporation can make the shareholders more familiar with the corporation by, for example, causing the shareholder to use their products, etc. through point exchange, thereby promoting long-term shareholding. In addition, when the point exchange with their products is performed, the corporation may set so that the shareholder can get more expensive their products by increasing an exchange rate to give some merit to the shareholder or issuing their product coupon. In addition, an incentive for promoting the long-term shareholding of the shareholder may be increased by cumulatively increasing a point grant rate depending on the shareholding period, etc.

In addition, relevance between a shareholder attribute and product preference can be obtained as data by associating an attribute to which shareholders belong with point exchange of products by the shareholders, thereby obtaining an indicator for arranging future product lineup. In addition, based on an attribute of shares of one corporation, cumulative data of product preference, share holding period, etc. can be obtained, so that an indicator in the marketing of their products can be obtained.

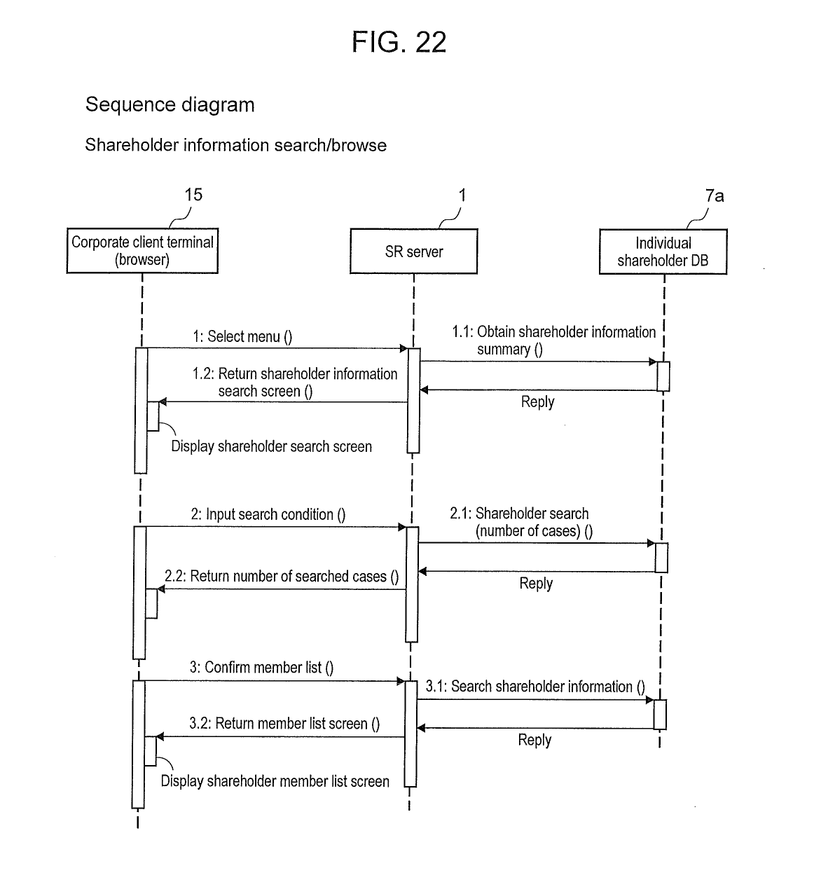

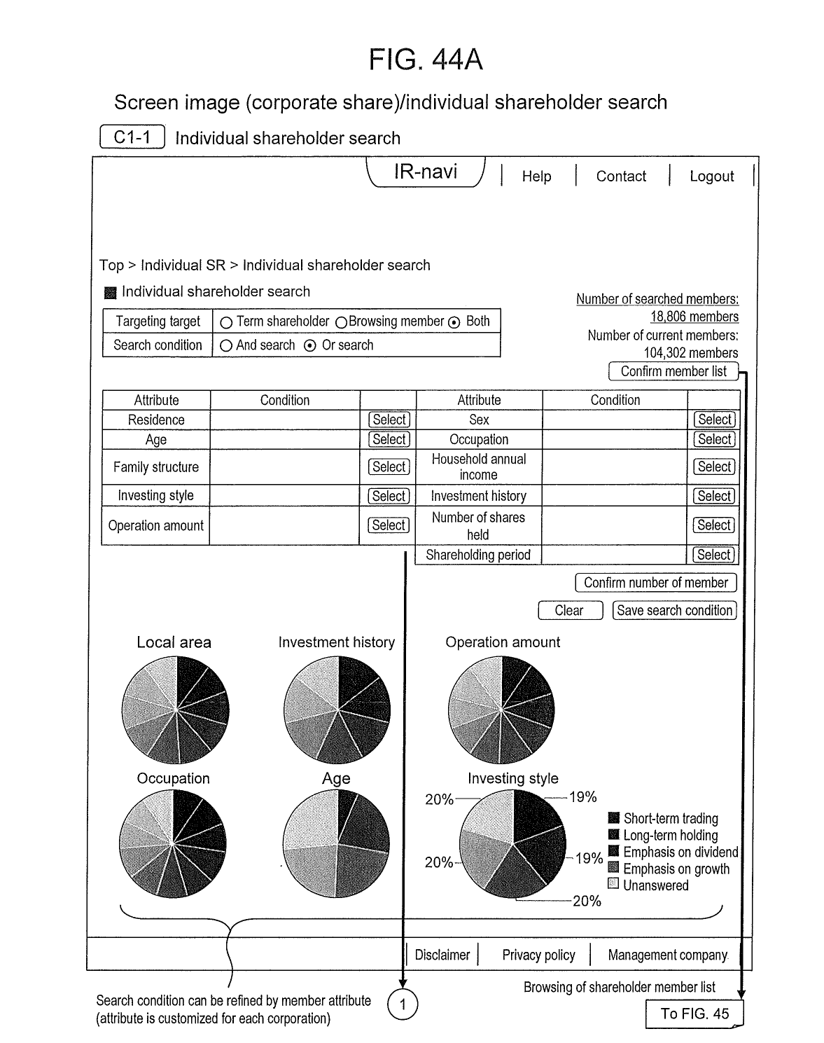

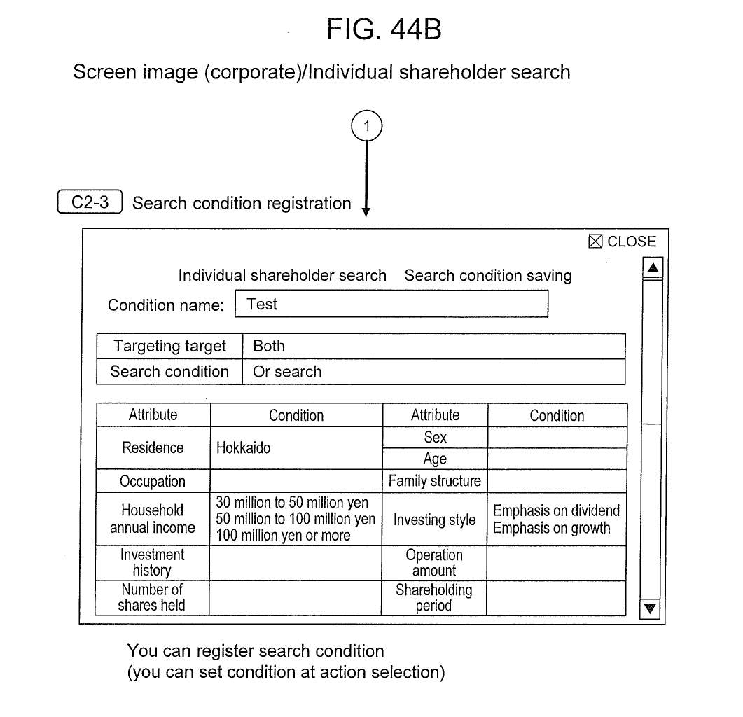

FIG. 22 is a sequence diagram illustrating a flow of a shareholder information search and browsing process. In addition, FIG. 43 is a screen transition diagram of an issuer corporation in the IR-navi. As illustrated in FIG. 43, the login is performed from a top screen of the IR-navi, the screen transitions to a top screen after the login. Here, the corporate client terminal (browser) 15 sends the menu selection (1) to the SR server 1. As illustrated in FIG. 43, the menu includes individual shareholder search 1-1, search condition list 2-1, individual shareholder action setting screen display 4-1, distribution result list screen display 5-1, etc. Here, for example, when a shareholder information search menu is selected, a shareholder information summary request is issues from the SR server 1 to the individual shareholder DB 7a (1.1), and using a securities code of the login corporation as a key, summary information (the number of shareholders, attribute (age, etc.) distribution-based number of members, etc.) is obtained by search of the individual shareholder corporate attribute table TB1-2 and the individual shareholder table TB1-3. The obtained summary information is replied to the SR server 1, and the SR server 1 returns a shareholder information search screen to the corporate client terminal (browser) 15 (1.2). Here, the shareholder search screen as illustrated in FIG. 44 is displayed. In the individual shareholder search display, conditions can be refined by a member attribute. For example, an investment history, an operation amount, distribution of age, etc., investing style, occupation, residence, etc. are indicated by pie charts. Based on the items, the refinement can be performed by a member attribute.

When a search condition is input to the corporate client terminal (browser) 15 (2), the SR server 1 performs shareholder search in the individual shareholder DB 7a (2.1). Here, using the securities code of the login corporation and the input search condition as keys, the mere number of cases is obtained by search of the individual shareholder corporate attribute table TB1-2, the individual shareholder table TB1-3, and the individual shareholder corporate extended attribute answer table TB1-6. The number of searched cases is returned to the SR server 1, and the SR server 1 returns the number of searched cases to the corporate client terminal (browser) 15 (2.2). Therefore, a display screen as illustrated in FIG. 44 can be obtained.

In addition, when the corporate client terminal (browser) 15 issues a confirmation request of a member list to the SR server 1 (3), the SR server 1 issues a search request of shareholder information to the individual shareholder DB 7a (3.1). Here, based on the search condition searched in the sequence of (2.1), data is obtained by search of the individual shareholder corporate attribute table TB1-2 and the individual shareholder table TB1-3 (3.1), and the obtained data is returned to the SR server 1 (3.2).

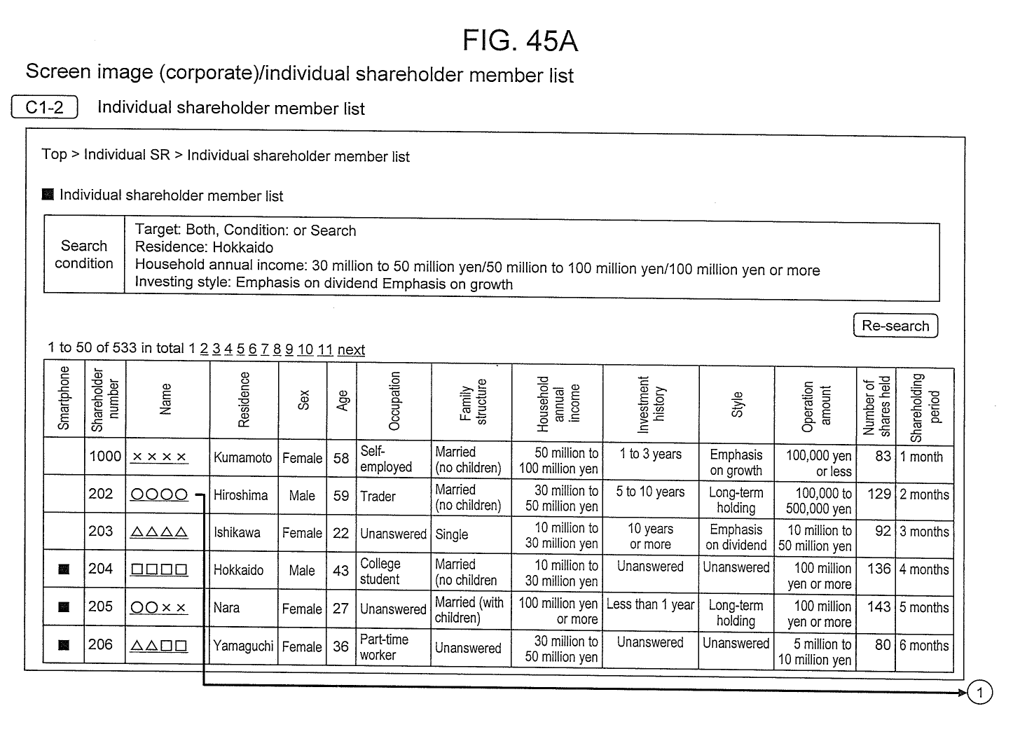

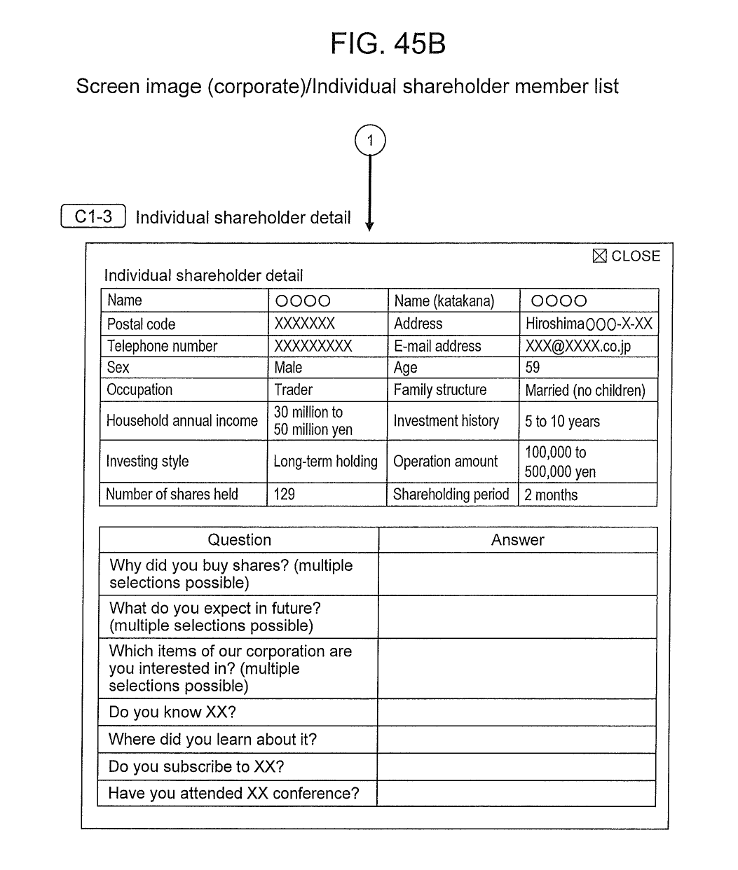

The SR server 1 returns a member list screen to the corporate client terminal (browser) 15 (3.2), and the individual shareholder member list screen as illustrated in FIG. 45 is displayed. FIG. 45 is an example of an individual shareholder member list, and a shareholder number, name, residence, sex, age, occupation, family structure, household annual income, an investment amount, an investing style, an operation amount, the number of shares held, holding period (month), etc. can be known for each of the shareholder numbers. In addition, the details of an individual shareholder can be obtained.

FIGS. 46A and 46B are diagrams illustrating screen display examples of action claim. Various distribution items to a shareholder, for example, distribution destination, an e-mail address, a message, SR news detail, disclosure start date, disclosure end date, suggestion contents, proposal contents, etc. are arbitrarily input and can be distributed to a certain user.

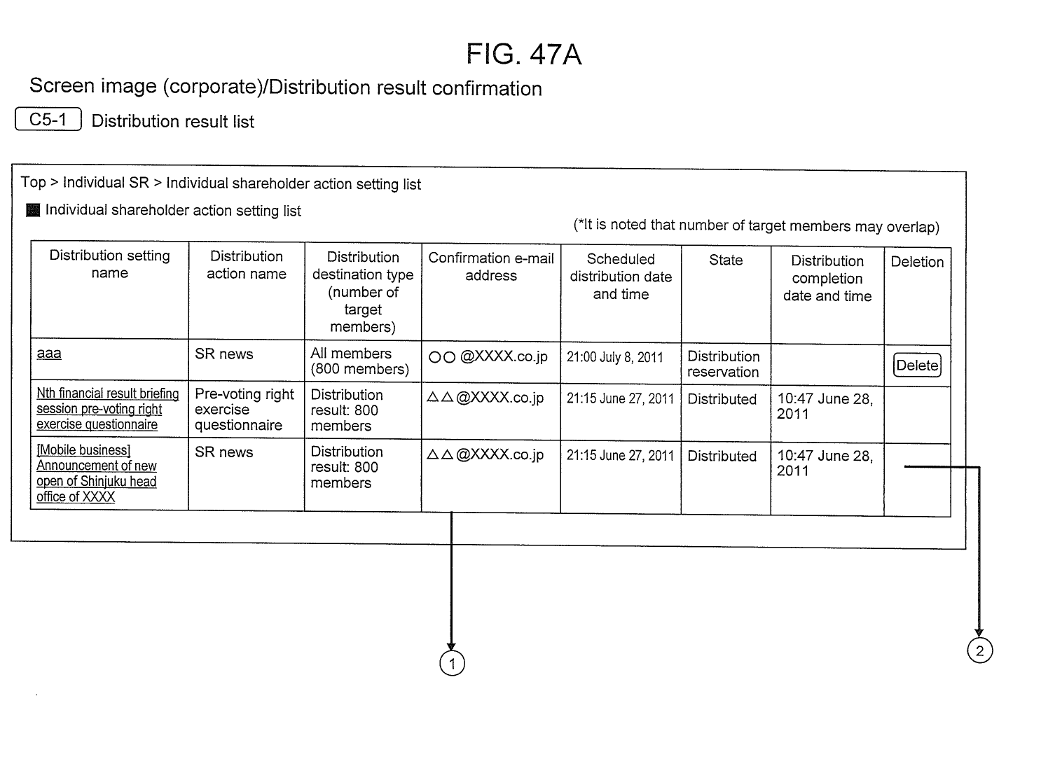

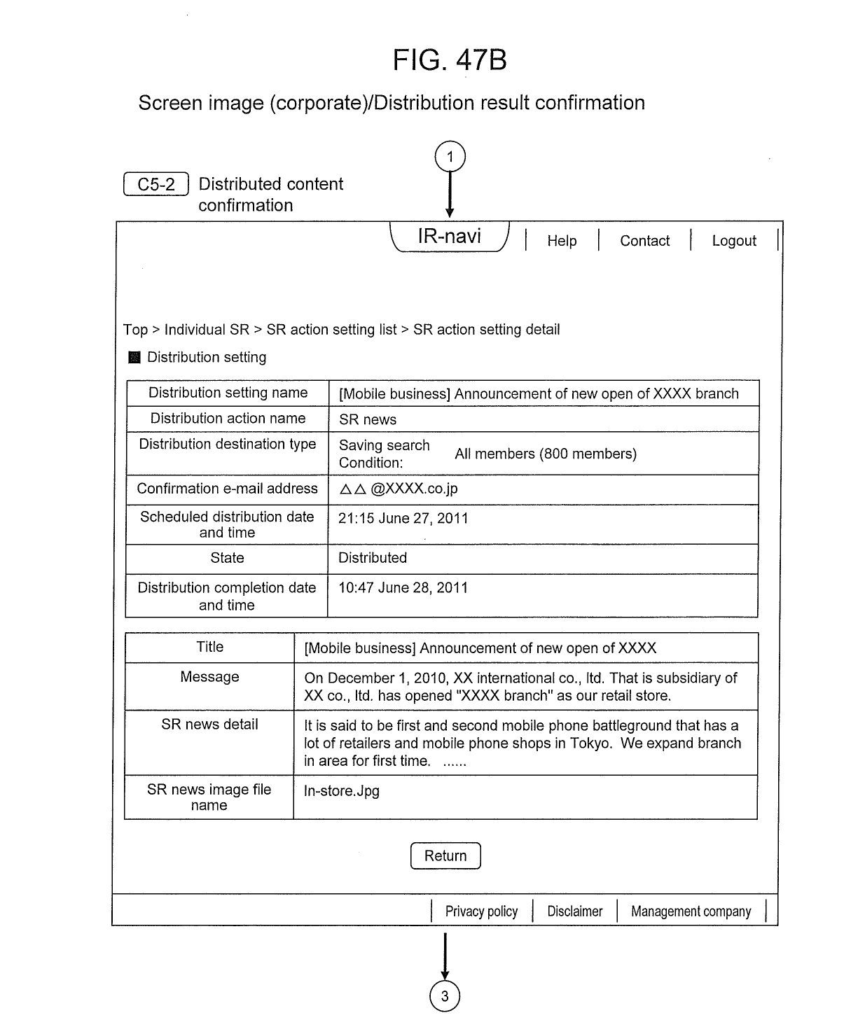

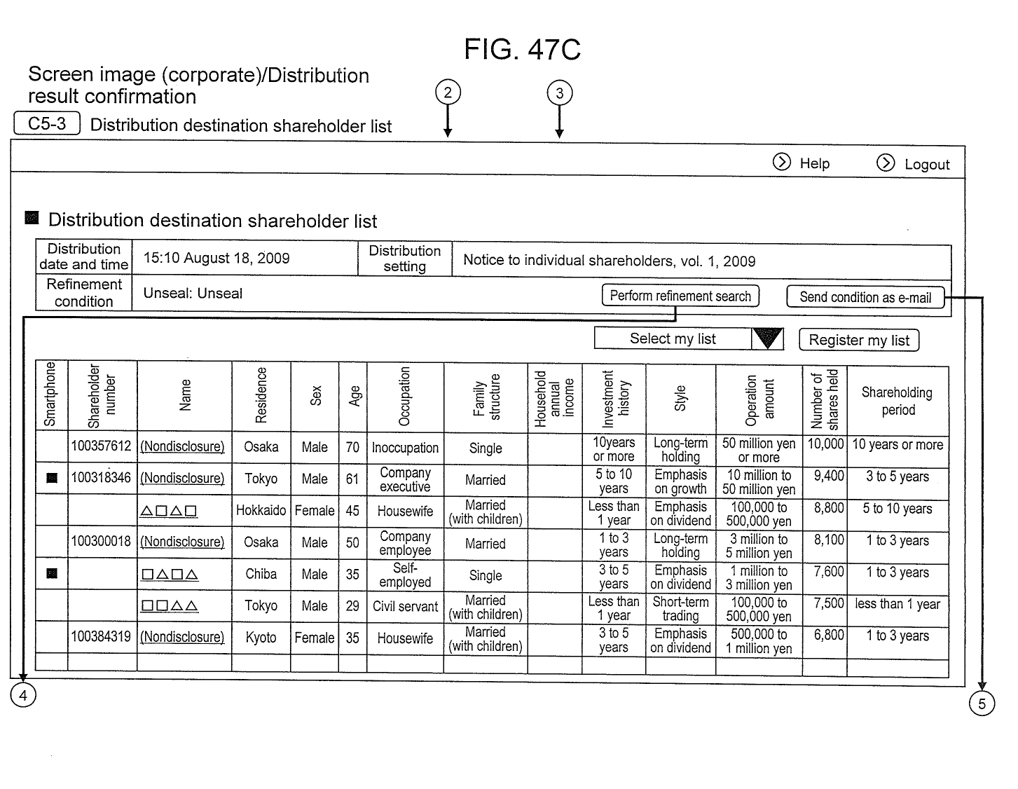

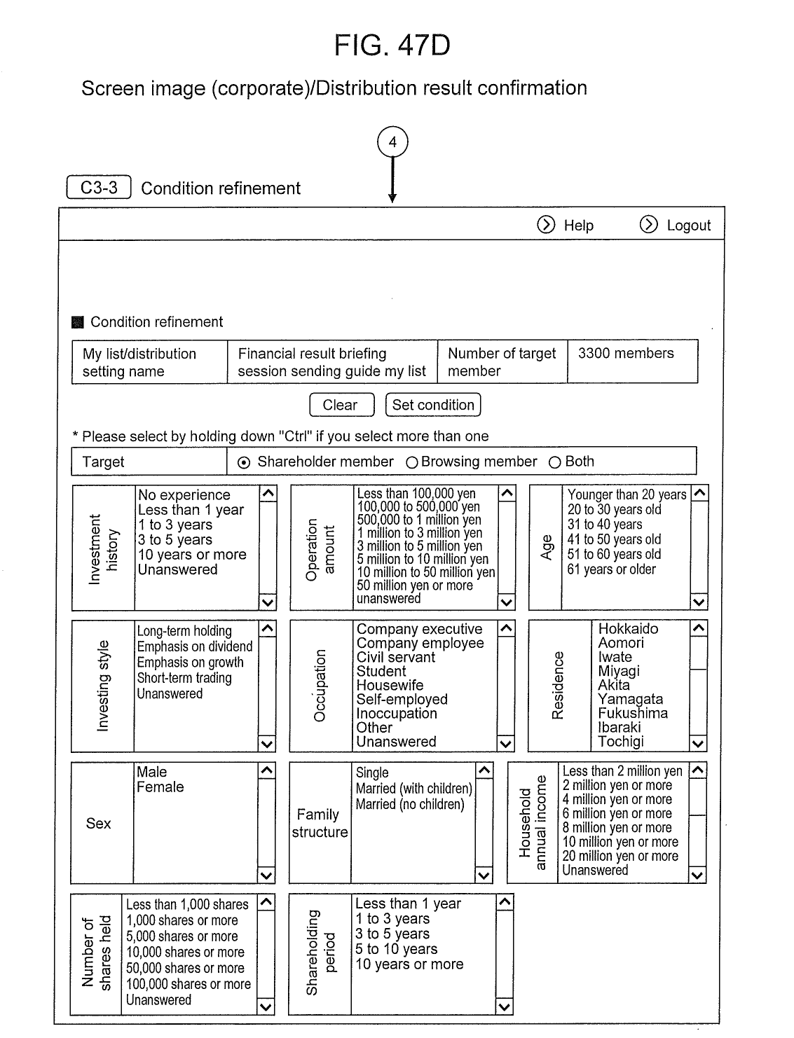

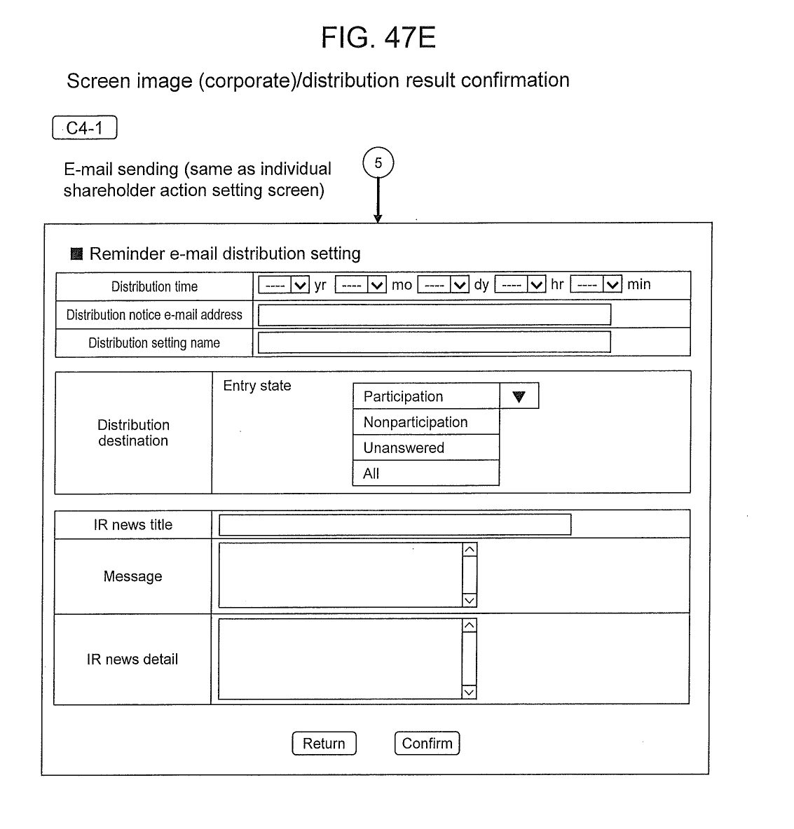

FIGS. 47A to 47E are diagrams illustrating examples of a confirmation screen of a distribution result. A distribution result list 5-1, distributed content confirmation display 5-2, and a distribution destination shareholder list 5-3 are displayed, and from the distribution destination shareholder list 5-3, shareholders can be arbitrarily refined by a condition such as household annual income, etc. In addition, a scheme for resending a reminder e-mail that has been sent to a shareholder once can be built by setting a distribution scheduled item, etc. In addition, as illustrated in FIG. 47D, condition refinement (C3-3) can performed at a corporate side, and as illustrated in FIG. 47E, an e-mail sending result can be confirmed at a corporate side (C4-1).

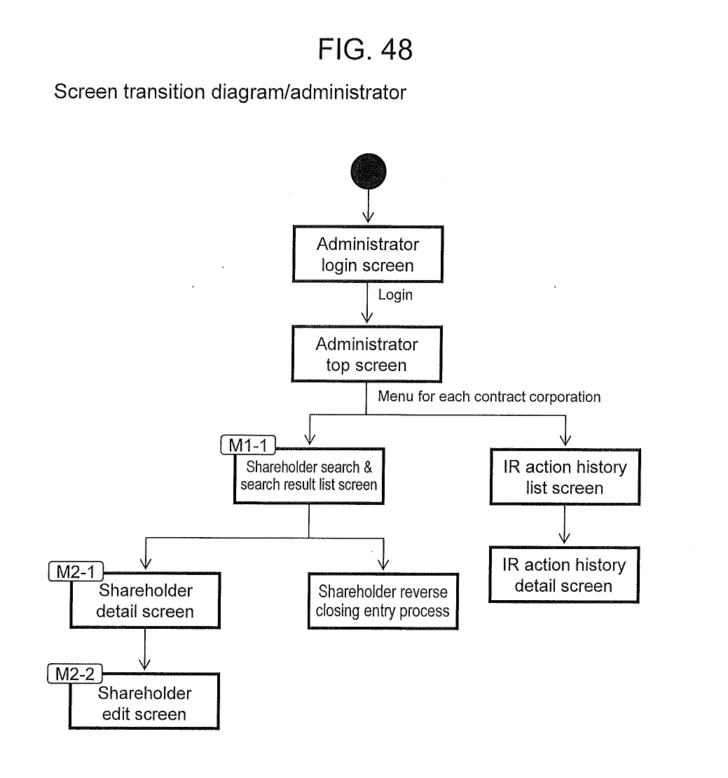

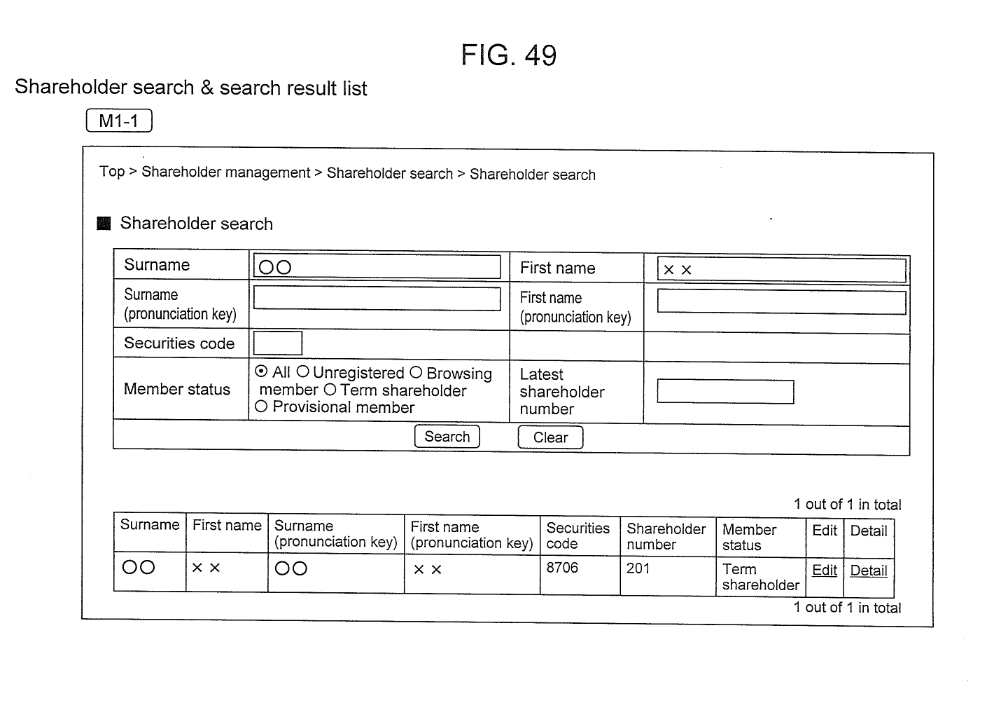

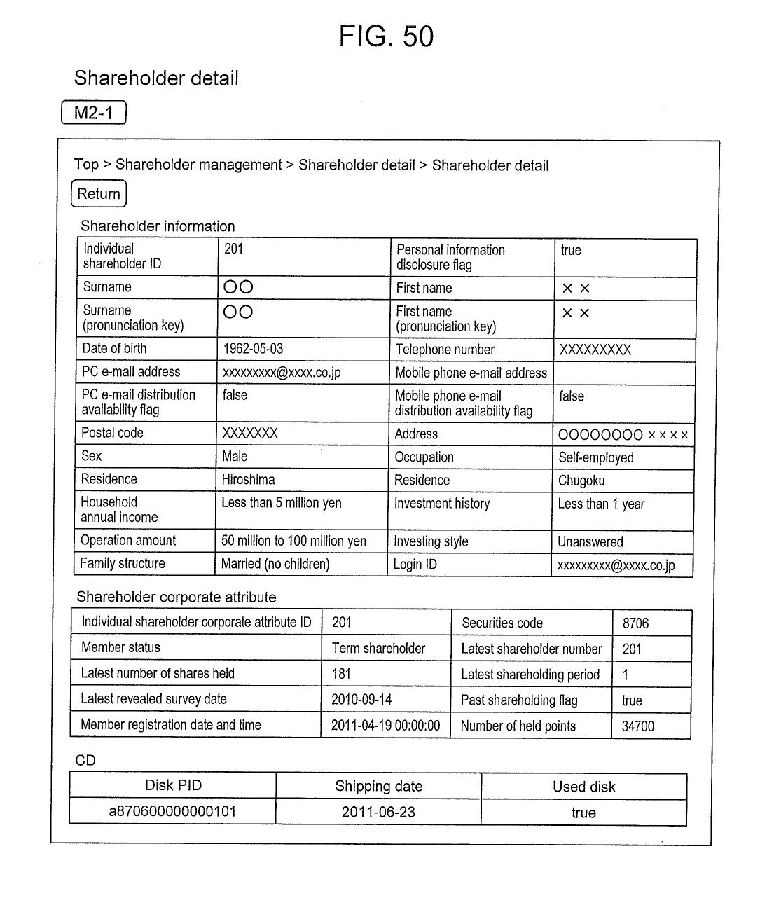

FIG. 48 is a diagram illustrating a screen transition example at an administrator side. As illustrated in FIG. 48, when login is performed from an administrator login screen, an administrator top screen is displayed, and a menu for each contract corporation is displayed. Here, as illustrated in FIG. 49, a shareholder search and search result list screen (M1-1) is displayed. At that time, an input and search start button of a search condition of a shareholder is displayed, and when the search is performed, as illustrated in FIG. 49, the search result is displayed. In addition, as illustrated in FIG. 50, when a shareholder detailed screen is displayed, as described above, the detail of shareholder information and the detail of a shareholder corporate attribute can be browsed. Here, information on a state of a CD is also displayed.

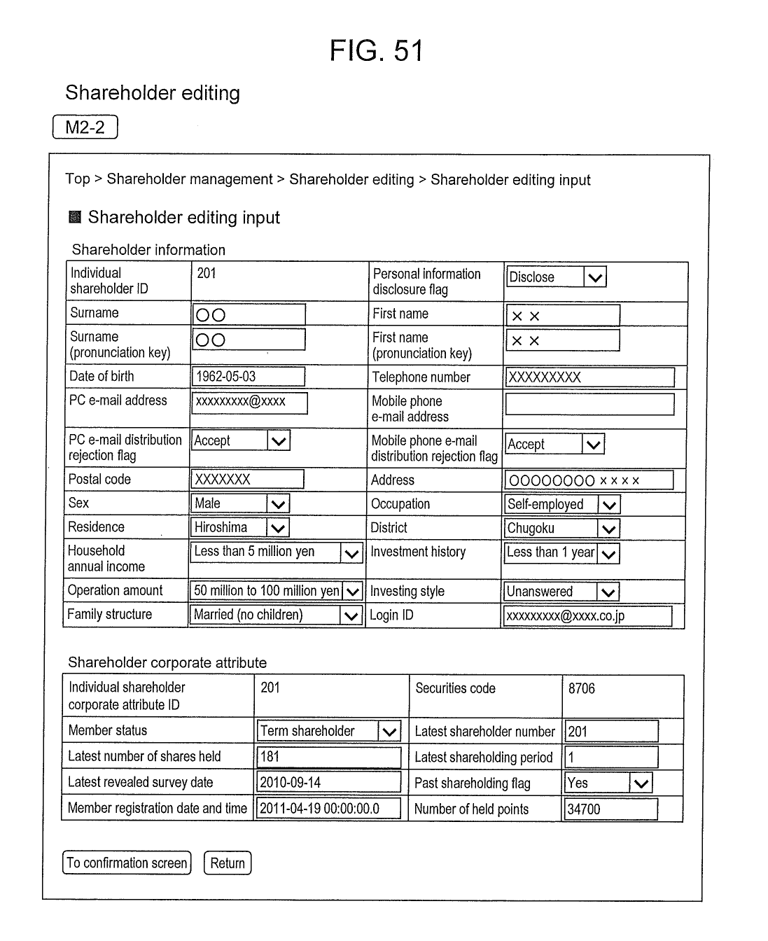

In addition, as illustrated in FIG. 51, when a shareholder edit screen is displayed, an operation such as change or update of shareholder information can be performed. The operation can be performed manually, and alternatively, the automatic edition can be performed by referring to latest information of the above-described various tables. Thus, latest information can be always browsed in the screen of FIG. 50, etc. by performing the edition automatically.

The description is made as described above, according to the embodiment of the present invention, promotion and activation of IR activity for individual investors and cost reduction of IR activity for individual investors in a corporation can be performed.

In addition, a new customer is easily acquired by provision of a new function.

The DB management of an individual shareholder of each corporation can be performed easily, and individual shareholder member list display, various sort processes, targeting of individual shareholders, a targeting condition save process, an IR action exercise process of individual shareholders (IR news distribution, video distribution, briefing session guidance, questionnaire, convening notice, etc.), a voting right exercise process can be performed simply by the digital system.

In addition, the digital system is contributed greatly to the automation for the management of individual shareholder and information update.

The configuration of the above-described embodiment is not limited to the accompanying drawings, and the embodiment can be changed as appropriate within the range in which the effect of the present invention can be exerted. In addition, the embodiment can be implemented by modifying as appropriate without departing from the range of the purpose of the present invention.

In addition, a program for realizing the functions described in the embodiment of the present invention may be recorded to a computer-readable recording medium, and the process in each of the units may be performed by reading the program recorded to the recording medium into a computer system and executing the program.

The present invention is available for a shareholder management system.

### DESCRIPTION OF SYMBOLS

A . . . shareholder management system
NT . . . network
1 . . . individual shareholder SR site server
1a . . . corporate information processing unit
1b . . . information management unit
1c . . . PW management unit
1d . . . communication unit
3 . . . corporate side shareholder info illation management server
3a . . . shareholder information processing unit
3b . . . information management unit
3c . . . PW management unit
3d . . . communication unit
5 . . . DB server
5a . . . communication unit
5b . . . DB searching unit
7a to 7d . . . database (DB)
11 . . . individual shareholder client terminal
11a . . . display unit (display)
11b . . . storage unit (memory, HDD)
11c . . . input unit (keyboard, mouse, etc.)
11d . . . communication unit
15 . . . corporate client terminal
17 . . . batch server

What is claimed is:

1. An individual shareholder management apparatus comprising:
an individual shareholder client terminal;
an individual shareholder management server connected to the individual shareholder client terminal through a network; and
a database group including an individual shareholder database connected to the individual shareholder management server, wherein
the individual shareholder database includes, for each individual shareholder, at least: an individual shareholder table that includes an attribute of an individual shareholder for each unique individual shareholder ID; an individual shareholder corporate attribute table that includes the individual shareholder ID that associates the individual shareholder and a corporation that has issued shares for each individual shareholder corporate attribute ID, a securities code that is a stock securities ID, and a latest shareholder number; and a storage medium log table that includes the individual shareholder corporate attribute ID, a storage medium unique ID, and a serial number enclosed with the storage medium and manages the contents in the storage medium and the provision state for each storage medium log ID for identifying a storage medium sent to the individual shareholder (by mail),
the individual shareholder management apparatus further includes an information processing unit to perform a search and check process of data of the database group, and
the information processing unit checks the storage medium unique ID obtained by reading the storage medium by the individual shareholder client terminal against a storage medium unique ID in the storage medium log table, obtains an individual shareholder corporate attribute ID corresponding to the checked storage medium log ID in the storage medium log table, obtains a latest shareholder number by search of the individual shareholder corporate attribute table using the individual shareholder corporate attribute ID as a key, provides the latest shareholder number for a client terminal held by the individual shareholder, checks the serial number replied from the individual shareholder against a serial number in the storage medium log table in response to the reply of the serial number from the individual shareholder, and obtains data that is stored in the individual shareholder corporate attribute table and associated by the individual shareholder corporate attribute ID on condition of the verification of the serial numbers.

2. The individual shareholder management apparatus according to claim 1, wherein
the information processing unit obtains and creates data that is data for displaying a personal information input screen on the client terminal and data for screen display for an input including an input field for inputting an e-mail address by search of the individual shareholder table, based on data of the individual shareholder table associated with the individual shareholder corporate attribute table and the individual shareholder corporate attribute ID associated by the obtained individual shareholder corporate attribute ID, prompts the client terminal to display the obtained data, and stores the e-mail address from the client terminal that is input in the screen display for an input, in the individual shareholder table.

3. The individual shareholder management apparatus according to claim 2, wherein
when the information processing unit stores the e-mail address, the information processing unit registers a temporary key for user registration confirmation to a timed key table that stores an individual shareholder ID of the individual shareholder table with a timed key, prompts the reference of a URL in which the temporary key is embedded by sending an e-mail including the URL to the e-mail address of the client terminal, extracts the temporary key from the URL in response to the reference of the URL, extracts an individual shareholder ID by search of the timed key table based on the temporary key, and extracts user information by search of the individual shareholder table based on the individual shareholder ID to obtain data for creating a login screen.

4. An individual shareholder management apparatus comprising:
an individual shareholder client terminal;
an individual shareholder management server that is connected to the individual shareholder client terminal through a network; and
a database group that includes an individual shareholder database and a distribution action database that are connected to the individual shareholder management server, an individual shareholder search condition database, and a voting right exercise database, wherein
the individual shareholder database includes, for each individual shareholder, at least: an individual shareholder table that includes an attribute of an individual shareholder for each unique individual shareholder ID; an individual shareholder corporate attribute table that includes the individual shareholder ID that associates the individual shareholder and a corporation that has issued shares, a securities code that is a stock securities ID, and a latest shareholder number for each individual shareholder corporate attribute ID,
the individual shareholder management apparatus further includes an information processing unit that performs a search and check process of data of the database group, and
in the distribution action database, the information processing unit obtains a search condition saving ID item that is identified by a distribution action ID of a distribution action setting table for setting a distribution action item for each distribution action ID, from a search condition distribution destination table including a distribution action ID and a search condition saving ID and stores the search condition saving ID item, searches a search condition saving table that includes a search condition item for each of the search condition saving IDs using the search condition saving ID as a key, obtains, based on the search condition saving ID, each search condition from a search condition saving mapping table that includes a search condition saving ID and an individual shareholder attribute ID, an individual shareholder range search condition table that identifies a condition of a search range of an individual shareholder for each individual shareholder range search condition ID, an individual shareholder range search condition option table that includes an individual shareholder range search condition ID and an option name for each individual shareholder range search condition option ID, an individual shareholder range search condition saving mapping table that includes a search condition saving ID and an individual shareholder range search condition option ID, and an extended attribute search condition saving mapping table that includes the search condition saving ID and an individual shareholder extended attribute option ID, in order to build search conditions,
the information processing unit searches, based on each of the obtained search conditions, the individual shareholder table, the individual shareholder corporate attribute table, and an individual shareholder corporate extended attribute answer table that includes the individual shareholder corporate attribute ID and the individual shareholder extended attribute option ID, obtains a distribution member by obtaining the individual shareholder ID of the individual shareholder table of corresponding data and the e-mail address of the individual shareholder client terminal,
in the distribution action database, the information processing unit registers data that is available for distribution to an individual shareholder distribution action log table that includes a distribution action ID, an individual shareholder ID for each log ID, and a distribution status based on the distribution action ID obtained by search under the condition that a distribution reservation time of a distribution action table is earlier than a start date and time of the process and the individual shareholder ID obtained in the distribution member obtaining process, and
in the voting right exercise database, the information processing unit obtains data by search of the individual shareholder distribution action log table using an individual shareholder data (individual shareholder ID) in login as a key in response to the login and reply to an e-mail that reports to the individual shareholder client terminal that voting right exercise is available and is sent based on the obtained e-mail address of the individual shareholder client terminal, obtains data of the distribution action setting table, a voting right exercise distribution setting table that includes the distribution action ID for each voting right exercise distribution setting ID, and a voting content table that includes a voting right exercise distribution setting ID and proposal content for each proposal ID, using the distribution action ID that is the data as a key, and prompts reply by sending data for displaying a voting right exercise screen on the individual shareholder client terminal.

5. An individual shareholder management apparatus comprising:
an individual shareholder client terminal;
an individual shareholder management server that is connected to the individual shareholder client terminal through a network; and
a database group that includes an individual shareholder database and a distribution action database that are connected to the individual shareholder management server, an individual shareholder search condition database, and a point exchange database, wherein
the individual shareholder database includes, for each individual shareholder, at least: an individual shareholder table that includes an attribute of an individual shareholder for each unique individual shareholder ID; and an individual shareholder corporate attribute table that includes the individual shareholder ID that associates the individual shareholder and a corporation that has issued shares, a securities code that is a stock securities ID, and a latest shareholder number for each individual shareholder corporate attribute ID,
the individual shareholder management apparatus further includes an info illation processing unit that performs a search and check process of data of the database group, and
the information processing unit receives a product type (product category) that is replied in response to a menu selection from the individual shareholder client terminal, obtains data from an exchange point master table that includes a securities code for each exchange point ID, a product ID, and an exchange point, and a product master table that stores the product display contents including a product name for each product ID in the point exchange database using the securities code and the product type (product category) in response to the menu selection as keys, sends the data for displaying the point exchange product screen to the individual shareholder client terminal, obtains data from the product master table and the exchange point master table using a product ID for identifying the product as a search key in response to a product specified by replying in accordance with a product selection operation, sends data for displaying the detail of the selected product on the client terminal, obtains the number of held points (balance) of the individual shareholder corporate attribute table of the client terminal in response to the selection confirmation, determines whether or not the selected product and the points can be changed by comparing the selected product and the points, newly writes an exchange point identified by the individual shareholder ID in a point exchange log table that includes an individual shareholder ID and an exchange point for each log ID in the point exchange database, and updates the number of held points of the individual shareholder corporate attribute table by recalculating new held points obtained after the point exchange.

6. An individual shareholder management apparatus comprising:
an individual shareholder client terminal;
an individual shareholder management server that is connected to the individual shareholder client terminal through a network; and
a database group that includes an individual shareholder database and a distribution action database that are connected to the individual shareholder management server, and an individual shareholder search condition database, wherein
the individual shareholder database includes, for each individual shareholder, at least: an individual shareholder table that includes an attribute of an individual shareholder for each unique individual shareholder ID; and an individual shareholder corporate attribute table that includes the individual shareholder ID that associates the individual shareholder and a corporation that has issued shares, a securities code that is a stock securities ID, and a latest shareholder number for each individual shareholder corporate attribute ID,
the individual shareholder management apparatus further includes an information processing unit that performs a search and check process of data of the database group, and
when an obtaining request of shareholder information is issued through login from the corporate client terminal, the information processing unit obtains individual shareholder corporate attribute information by search of the individual shareholder corporate attribute table and the individual shareholder table through the individual shareholder corporate attribute table using the corporate securities code of the corporate client terminal as a search key, prompts an input of a search condition regarding the individual shareholder corporate attribute in the corporate client terminal in response to the replied shareholder corporate attribute information, searches the individual shareholder corporate attribute table, the individual shareholder table, and an individual shareholder corporate extended attribute answer table that includes the individual shareholder corporate attribute ID and the individual shareholder extended attribute option ID, in the individual shareholder database based on a securities code of the login corporation and the input search condition, in response to the input, replies after obtaining only a number of cases that has been searched for, and creates statistical data.

7. The individual shareholder management apparatus according to claim 6, wherein
the information processing unit registers the search condition to the individual shareholder corporate attribute table and the individual shareholder table as a search condition of the individual shareholder based on the statistical data, obtains data by search of the registered individual shareholder corporate attribute table and the individual shareholder table in response to a shareholder information search request from the corporate client terminal, and replies to the corporate client terminal by sending an individual shareholder member list created based on the data.

8. An individual shareholder management method using an individual shareholder management apparatus including an individual shareholder client terminal, an individual shareholder management server that is connected to the individual shareholder client terminal through a network, and a database group that includes an individual shareholder database connected to the individual shareholder management server, for each individual shareholder, the individual shareholder database including at least: an individual shareholder table that includes an attribute of an individual shareholder for each unique individual shareholder ID; an individual shareholder corporate attribute table that includes an individual shareholder ID that associates the individual shareholder and a corporation that has issued shares for each individual shareholder corporate attribute ID, a securities code that is a stock securities ID, and a latest shareholder number; and a storage medium log table that includes the individual shareholder corporate attribute ID, a storage medium unique ID, and a serial number enclosed with the storage medium and manages the contents in the storage medium and the provision state for each storage medium log ID for identifying a storage medium sent to the individual shareholder (by mail), the individual shareholder management apparatus used in the individual shareholder management method further including an information processing unit to perform a search and check process of data of the database group, and the individual shareholder management method causing the information processing unit to execute:
a step of checking the storage medium unique ID obtained when the storage medium is read against a storage medium unique ID in the storage medium log table and obtaining an individual shareholder corporate attribute ID of the storage medium log table;
a step of obtaining a latest shareholder number by search of the individual shareholder corporate attribute table using the individual shareholder corporate attribute ID as a key;
a step of providing the latest shareholder number for a client terminal held by the individual shareholder and checking the serial number replied from the individual shareholder against a serial number in the storage medium log table in response to the reply of the serial number from the individual shareholder; and
a step of obtaining data that is stored in the individual shareholder corporate attribute table and associated by the individual shareholder corporate attribute ID on condition of the verification of the serial numbers.
